(19) United States
(12) Patent Application Publication
(10) Pub. No.: US 2024/0405842 A1
(43) Pub. Date: Dec. 5, 2024

(54) INITIAL ACCESS PROCEDURE WITH RIS

(71) Applicant: QUALCOMM Incorporated, San Diego, CA (US)

(72) Inventors: Saeid SAHRAEI, San Diego, CA (US); Hung Dinh LY, San Diego, CA (US); Yu ZHANG, San Diego, CA (US); Krishna Kiran MUKKAVILLI, San Diego, CA (US); Peter GAAL, San Diego, CA (US); Wanshi CHEN, San Diego, CA (US)

(21) Appl. No.: 18/691,438

(22) PCT Filed: Nov. 1, 2021
(86) PCT No.: PCT/CN2021/127862

§ 371 Date: Mar. 12, 2024

(51) Int. Cl. H04B 7/06; H04B 7/024; H04B 7/04

(52) U.S. Cl. CPC H04B 7/06966; H04B 7/024; H04B 7/04013

(57) ABSTRACT

A reconfigurable intelligent surface (RIS) may include multiple sub-RIS, and the base station may configure the RIS and the multiple sub-RIS with RIS sync raster including multiple center frequencies. The RIS may be configured to simultaneously apply different water-markings and reflect the incident beam into different beams in different directions. The base station may perform a beam-sweeping by transmitting synchronization signal blocks (SSBs) on multiple SSB beams, and the RIS may receive one SSB beam of the multiple SSB beams and reflect the SSB beams on the RIS sync raster. A UE may be configured to monitor the base sync raster and the RIS sync raster for a suitable SSB beam, and transmit a feedback report to the base station indicating the suitable beam. The base station may configure the RIS based on the feedback report received from the base station for beam management.

### TECHNICAL FIELD

The present disclosure relates generally to communication systems, and more particularly, to a method of wireless communication including an initial access procedure using a reconfigurable intelligent surface (RIS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a user equipment (UE), a base station, and a reconfigurable intelligent surface (RIS). The RIS may include multiple sub-RIS, and the base station may configure the RIS and the multiple sub-RIS with RIS sync raster including multiple center frequencies. The RIS may be configured to simultaneously apply different water-markings and reflect the incident beam into different beams in different directions simultaneously. The base station may perform a beam-sweeping by transmitting synchronization signal blocks (SSBs) on multiple SSB beams, and the RIS may receive one SSB beam of the multiple SSB beams and reflect the SSB beams on the RIS sync raster. A UE may be configured to monitor the base sync raster and the RIS sync raster for a suitable SSB beam, and transmit a feedback report to the base station indicating the suitable beam. The base station may configure the RIS based on the feedback report received from the base station for beam management.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A illustrates an example of wireless communication.

FIG. 4B illustrates an example of wireless communication.

FIG. 5A illustrates an example of a synchronization signal block (SSB) of a method of wireless communication.

FIG. 5B illustrates an example of beam-sweeping.

FIG. 6A is an example of beam-sweeping.

FIG. 6B is an example of beam-sweeping.

FIG. 7A is an example of frequency-domain watermarking with a RIS.

FIG. 7B is an example of frequency-domain watermarking with a RIS.

FIG. 8 is an example of beam-sweeping including the RIS.

FIG. 9 is a call-flow diagram of a method of wireless communication

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus.

FIG. 17 is a diagram illustrating an example of a hardware implementation for an example apparatus.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

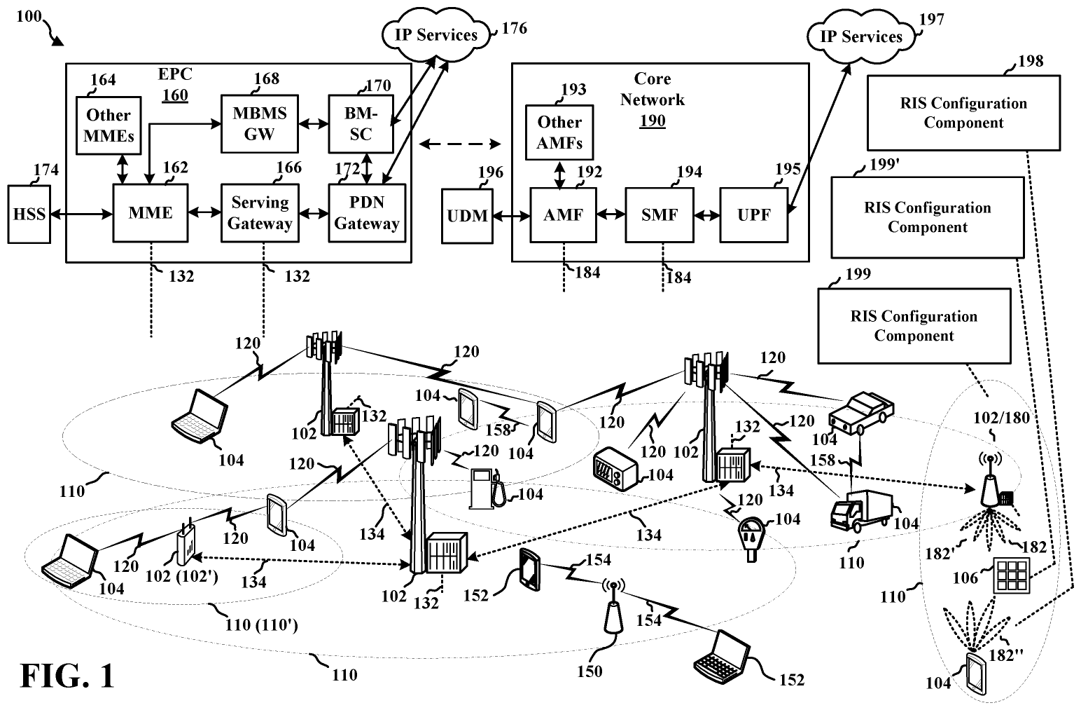

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FRI, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

A reconfigurable intelligent surface (RIS) 106 may be provided to control the signal transmissions between the base stations 102/180 and/or UEs 104. The RIS 106 may refer to a programmable structure, e.g., a programmable meta-surface, that may control the propagation of electromagnetic waves by changing the electric and magnetic properties of the surface. The programmable meta-surface may include an artificial electromagnetic surface configured to manipulate the propagation of the electromagnetic waves. For example, the RIS 106 may reflect the beam signals between the base stations 102/180 and/or UEs 104 to different directions to improve the overall quality of the wireless communication.

Referring again to FIG. 1, in certain aspects, the UE 104 may include a RIS configuration component 198 configured to monitor a first synchronization (sync) raster and a second sync raster for a set of beams including a second set of beams being simultaneously received and associated with the second sync raster, the first sync raster being associated with a first set of beams from a base station and the second sync raster being associated with the second set of beams reflected at a RIS, select a first beam of the set of beams, the first beam being a most suitable beam among the set of beams, and transmit, to the base station, a response to the first beam indicating the first beam and a selected sync raster associated with the first beam. In certain aspects, the base station 180 may include a RIS configuration component 199 configured to transmit, to a RIS, a configuration of a second sync raster for the RIS to reflect a first beam into a second set of beams, the second set of beams being associated with the second sync raster, and transmit a first set of beams including the first beam, the first set of beams being associated with a first sync raster, each beam of the first set of beams being transmitted in different directions. In certain aspects, the RIS 106 may include a RIS configuration component 199′ configured to receive, from a base station, a first beam among a first set of beams associated with a first sync raster, and reflect the first beam into a second set of beams associated with a second sync raster, the second set of beams being reflected simultaneously.

Although the following description may be focused on 5G NR, the concepts described herein may be applicable to other similar areas, such as LTE, LTE-A, CDMA, GSM, and other wireless technologies.

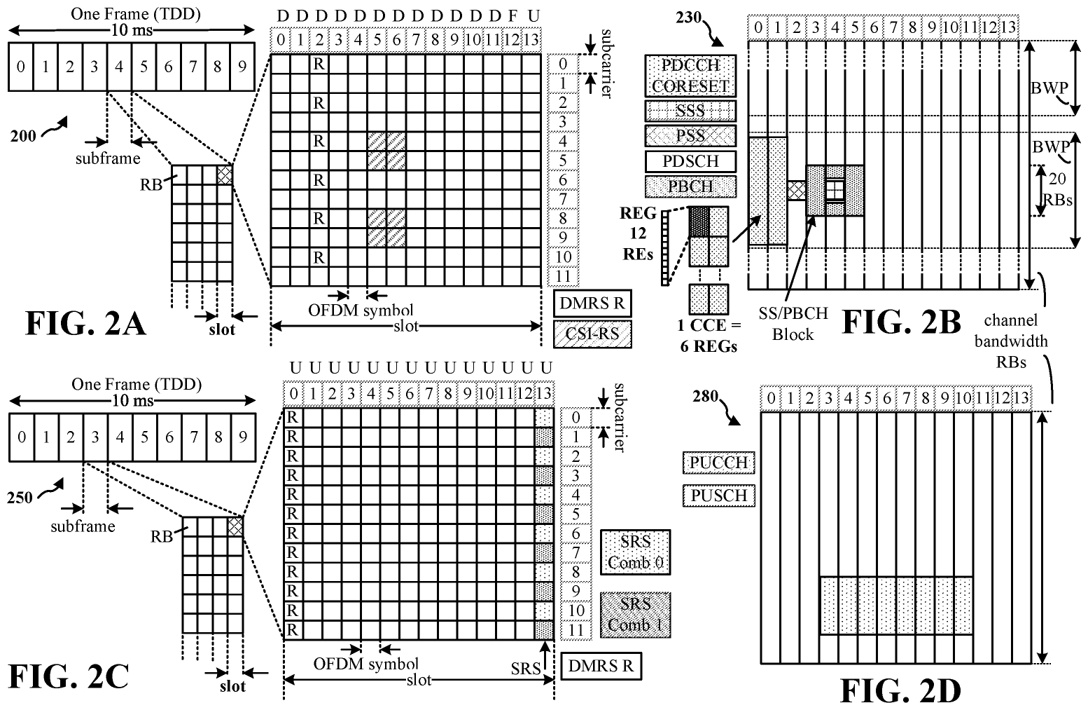

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2″ slots/subframe. The subcarrier spacing may be equal to 2ª *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

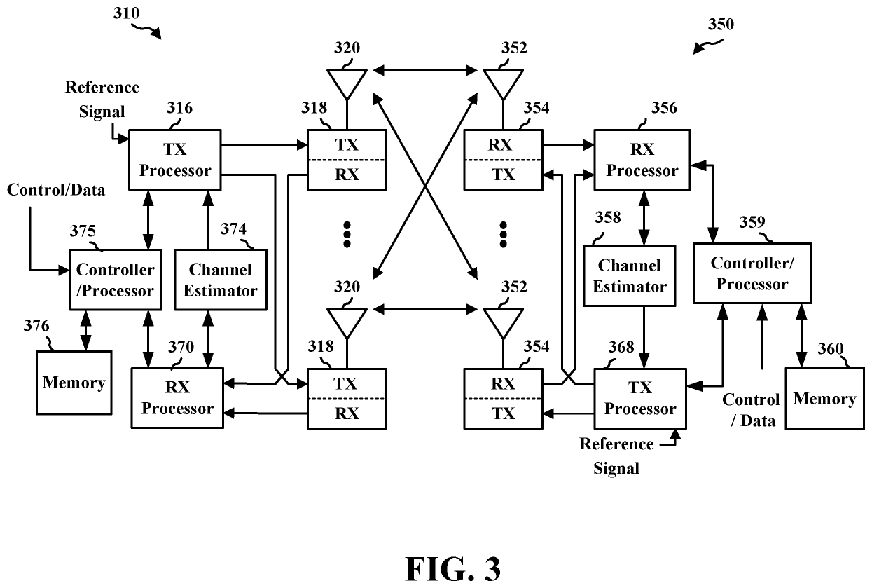

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

In some aspects, a 5G NR network may implement one or more configurations to increase the network throughput and achieve improved transmission gains. In one aspect, a massive 5G MIMO antenna configuration may be provided to increase the network throughput. That is, active antenna units may be provided to achieve higher beamforming gains, and individual RF chains may be configured per the active antenna ports to increase the network throughput. In another aspect, a power consumption may be increased due to the use of the active antenna units. That is, the active antenna units are active devices that may have power consumption, and the implementation of the active antenna units may increase the power consumption.

In some aspects, the network may include passive devices to improve the coverage without significantly increasing the power consumption. In one aspect, the passive devices may include a programmable meta-surface. The programmable meta-surface may refer to an artificial electromagnetic surface configured to manipulate propagation of electromagnetic waves. In one example, the programmable meta-surface may include a reconfigurable intelligent surface (RIS), which may extend the network coverage with negligible power consumption. The RIS may refer to a programmable structure, e.g., a programmable meta-surface, that may control the propagation of electromagnetic waves by changing the electric and magnetic properties of the surface.

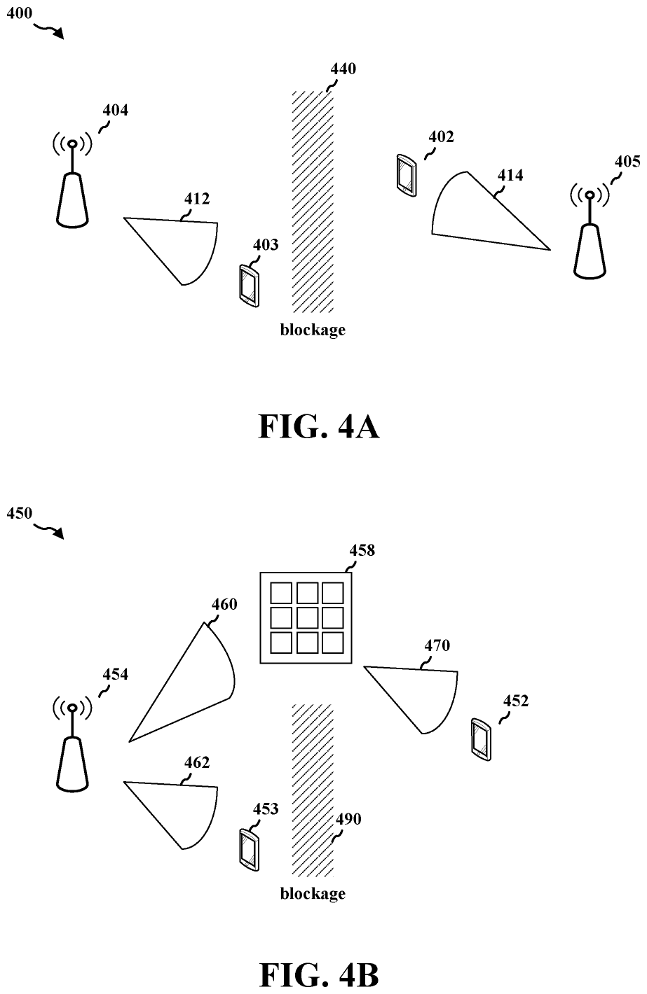

FIGS. 4A and 4B illustrate examples of wireless communication. FIG. 4A illustrates a wireless communication 400 including a first base station 404 and a second base station 405, a first user equipment (UE) 402 and a second UE 403, and a blockage 440. The blockage 440 may include a structure or an object that may block a first beam (or signal) 412 transmitted by the first base station 404. Accordingly, from the perspective of the first UE 402, the signal from the first base station 404 may have a poor quality, e.g., low signal-to-noise ratio (SNR), high block error rate (BLER), etc. Accordingly, to reach the first UE 402 behind the blockage 440, the network may include a second base station 405 to reach the first UE 402. That is, the first UE 402 may rely on the second beam 414 transmitted from the second base station 405 to communicate with the network. In one example, the second base station 405 may act as a relay node, and the first base station 404 may communicate with the first UE 402 via the second base station 405, i.e., a relay node. The second base station 405 as the active relay node may have a relatively higher power consumption.

FIG. 4B illustrates a wireless communication 450 including a first base station 454, a first UE 452 and a second UE 453, a RIS 458, and a blockage 490. The blockage 490 may include a structure or an object that may block a first beam (or signal) 462 transmitted by the first base station 454. Accordingly, from the perspective of the first UE 452, the signal from the first base station 454 may have a poor quality, e.g., low signal-to-noise ratio (SNR), high block error rate (BLER), etc. The RIS 458 may be a near passive device that may be configured to reflect the impinging or incident electromagnetic wave (or a received signal) to a desired or configured direction. That is, the RIS 458 may receive the second beam (or signal) 460 from the first base station 454 and reflect the second beam 460 to a reflected beam 470 in a first direction towards the first UE 452. Here, the reflection direction may be controlled by the first base station 454. That is, based on the base station's understanding of the first direction for the RIS 458 to reflect the second beam 460, the base station may instruct the RIS 458 to control the propagation of the second beam 460 to the first direction towards the first UE 452.

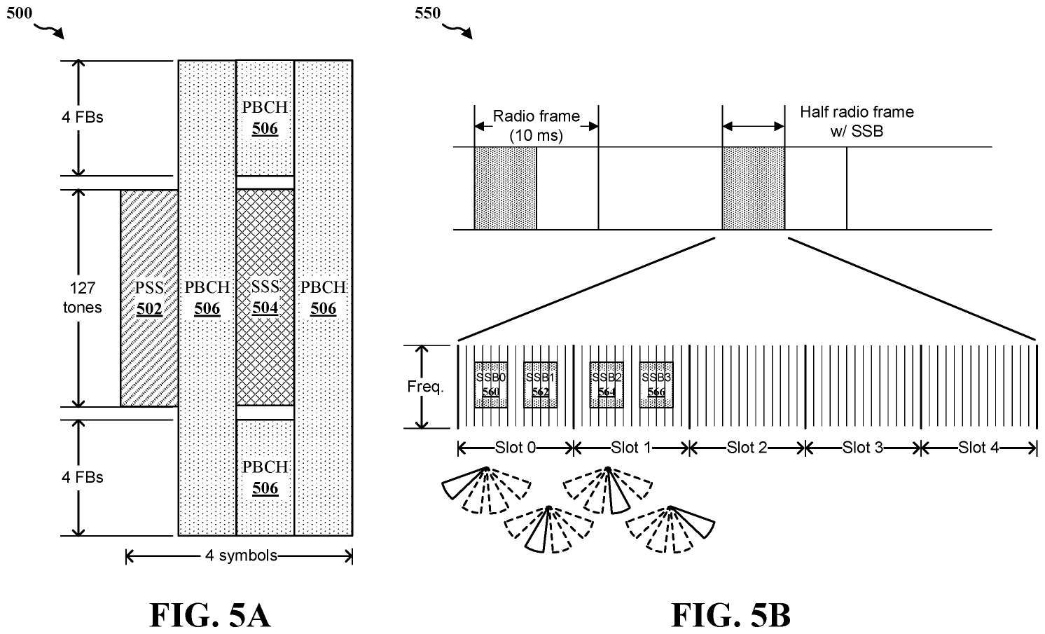

FIG. 5A illustrates an example of a synchronization signal block (SSB) 500 of a method of wireless communication. The UE may acquire DL synchronization (sync) and system information based on the SSB. The SSB 500 may span 4 OFDM symbols with 1 symbol for a PSS 502, 2 symbols for a PBCH 506, and I symbol with an SSS 504 and PBCHs 506 frequency domain multiplexed with each other. By way of example, in some wireless communication systems, an SCS of 15 kHz or 30 kHz may be used for FRI and SCS of 120 kHz or 240 kHz may be used for FR2. The PSS 502 may use a length 127 frequency domain-based M-sequence (mapped to 127 subcarriers). For example, the PSS 502 may have 3 possible sequences. The SSS 504 may use a length 127 frequency domain-based Gold code sequence (e.g., 2 M-sequences) (mapped to 127 subcarriers). By way of example, there may be a total of 1008 possible sequences for the SSS 504. The PBCH 506 may be QPSK modulated, and the UE may coherently demodulate the PBCH 506 using an associated DM-RS from the base station. During an initial search, a UE searcher may use a sliding window and correlation technique to look for the PSS 502. For each timing hypothesis associated with the sliding window, the UE may try all 3 possible PSS 502 sequences and N frequency domain hypothesis to account for Doppler, internal clock frequency shifts, and any other frequency errors.

FIG. 5B illustrates an example of beam-sweeping 550. The base station may transmit the SSBs on different beams in different directions in a time division multiplexing (TDM) fashion. That is, the base station may be configured to transmit multiple SSBs, where the multiple SSBs are transmitted on different beams sequentially in different directions. Here, half of a radio frame is configured with the SSB beam-sweeping, and first two slots are configured with four SSBs; a first SSB0 560, a second SSB1 562, a third SSB 564, and a fourth SSB 566. The base station may sequentially transmit the first SSB0 560 on a first beam in a first direction, the second SSB0 562 on a second beam in a second direction, the third SSB0 564 on a third beam in a third direction, and the fourth SSB3 566 on a fourth beam in a fourth direction.

A raster may refer to a collection of frequency positions. A synchronization (sync) raster may indicate the frequency positions of the synchronization block that can be used by the UE for system acquisition when explicit signaling of the SSB position is not present. In some aspects, a global synchronization raster may be defined for all frequencies. The frequency position of the SSB may be defined as SSB reference frequency position (SSREF) with corresponding global synchronization channel number (GSCN). The parameters defining the SSREF and GSCN may be specified for at least some frequency ranges.

The base station may transmit the SSBs on multiple frequency locations, e.g., the sync raster. The sync raster may indicate the frequency positions of the SSB that can be used by the UE for system acquisition. That is, the sync raster may be associated with a set of center frequencies, and the base station may transmit the SSBs on multiple frequency locations, each frequency location of the multiple frequency locations being associated with one center frequency of the set of center frequencies. The UE may monitor the sync raster to receive the SSBs transmitted by the base station.

In one aspect, a UE located in a direction associated with one DL beam may see or detect a single SSB and the UE may be unaware of other SSBs transmitted from the cell. For example, a UE may be disposed at a second direction associated with the beam including the second SSB1 562, and the UE may receive the second SSB1 562 from the base station, but the UE may not receive the first SSB0 560, the third SSB 564, or the fourth SSB 566.

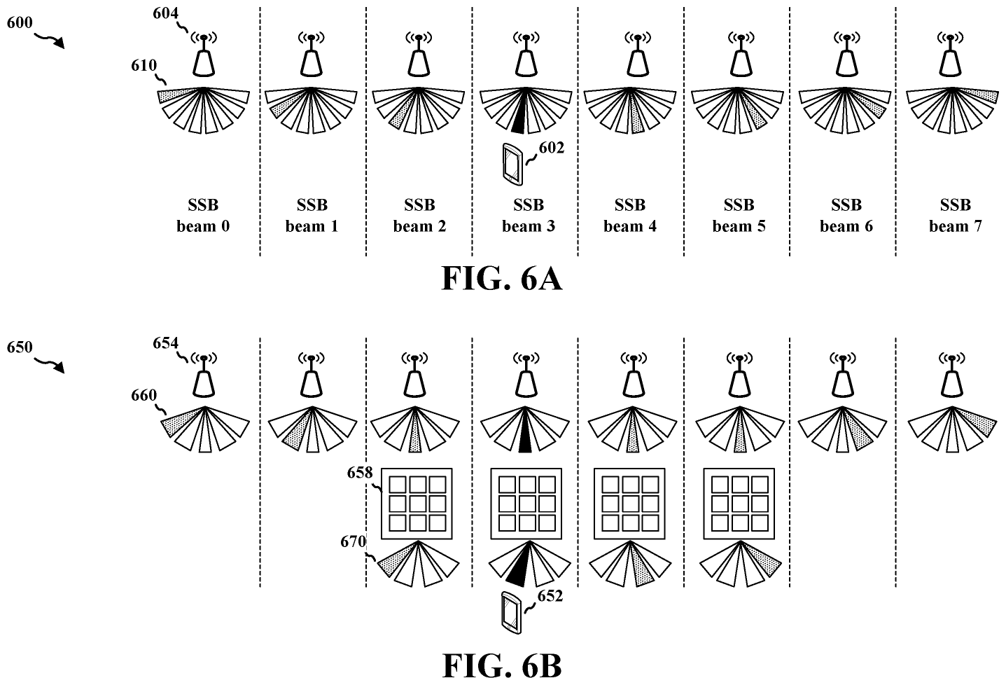

FIGS. 6A and 6B illustrate examples of beam-sweeping. FIG. 6A illustrates a first example of beam-sweeping 600. The first example of beam-sweeping 600 may include a UE 602 and a base station 604. The base station 604 may transmit the SSBs on different beams in different directions in the TDM fashion. That is, the base station 604 may be configured to transmit multiple SSBs, where the multiple SSBs may be transmitted on different SSB beams 610 sequentially in different directions. In one example, the base station 604 may be configured to transmit eight (8) SSBs on eight (8) SSB beams in eight (8) different directions. The UE 602 may be located in a direction associated with a fourth SSB beam. The UE 602 may detect and measure at least one beam of the eight (8) SSB beams, and determine that the fourth SSB beam is the most suitable beam based on at least one measurement of the at least one beam detected among the eight (8) SSB beams. The UE 602 may respond back to the base station 604 and indicate that the fourth SSB beam in the fourth direction is the most suitable beam for the UE 602. The base station 604 may manage the DL beam based on the response received from the UE 602.

FIG. 6B illustrates a second example of beam-sweeping 650. The second example of beam-sweeping 650 may include a UE 652, a base station 654, and a RIS 658. The base station 654 and the RIS 658 may perform a proper beam-planning to accommodate RIS beam-sweeping for the initial access process. The base station 654 may repeat a subset of the beams towards the RIS 658, and the base station 654 may configure the RIS 658 to perform beam-sweeping. That is, the base station 654 may be configured to transmit multiple SSBs, where the multiple SSB beams 660 are transmitted on different beams sequentially in different directions, but a subset of the SSB beams towards the RIS 658 may be repeated while the RIS 658 reflects one SSB beam to the reflected SSB beams 670 in different directions to perform beam-sweeping.

In one example, the base station 654 may be configured to transmit five (5) SSBs on five (5) SSB beams in five (5) different directions. The base station 654 may repeat the third SSB beam directed towards the RIS 658 four (4) times, and the RIS 658 may reflect the third SSB beam in four different directions to send the reflected SSB beams 670 in the four different directions. The UE 652 may be located in a direction associated with a second reflected SSB beam. The UE 652 may detect and measure at least one beam of the five (5) SSB beams or the four (4) reflected SSB beams, and determine that the second reflected SSB beam is the most suitable beam based on at least one measurement of the at least one beam detected at least one beam of the five (5) SSB beams or the four (4) reflected SSB beams. The UE 652 may respond back to the base station 654 and indicate that the SSB beam 3 associated with the third SSB beam and the second reflected SSB beam is the most suitable beam for the UE 652. The base station 654 may manage the DL beam with the RIS 658 based on the response received from the UE 652. Here, the above procedure may be transparent to the UE 652, and the UE may not realize that the SSB beam and the subsequent transmissions are performed via the RIS 658.

In one aspect, to maintain the field of view while repeating the transmission of a subset of the SSB beams to perform SSB beam-sweeping at the RIS, the base station may widen the SSB beams to cover the same field of view with a reduced number of SSB beams. For example, FIG. 6A illustrates that the multiple SSB beams 610 includes eight (8) SSB beams while FIG. 6B illustrates that the multiple SSB beams 660 includes five (5) SSB beams to cover the same field of view, and therefore, each SSB of the multiple SSB beams 660 of FIG. 6B is configured wider than each SSB of the multiple SSB beams 610 of FIG. 6A. The wider beam may mean that the UE 652 may receive a weaker signal. Accordingly, the coverage of the SSB beams may be reduced.

In another aspect, designing a wider beam may impose an additional configuration at the base station 654. From the base station's perspective, the base station 654 may not distinguish whether the UE 652 received the SSB signal directly from the base station 654 or the reflected SSB signal from the RIS 658. For example, in FIG. 6B, the UE 652 may report that the SSB beam 3 is the suitable beam, but the base station 654 may not determine whether the UE 652 received the third SSB beam of the multiple SSB beams 660 directly from the base station 654 or the second reflected SSB beam of the reflected SSB beams 670 from the RIS 658. The configuration of the RIS 658 to serve the UE 652 may be based on whether the UE 652 received the third SSB beam of the multiple SSB beams 660 directly from the base station 654 or the second reflected SSB beam of the reflected SSB beams 670 from the RIS 658.

In another aspect, the repeated transmission of the subset of the SSB beams may further reduce the efficiency of the initial access process. In one example, the RIS may be permanently or temporarily blocked from the base station by an object, and the subset of the beams may be transmitted in a blocked direction resulting in the modified beam-sweeping being inefficient. Furthermore, the example illustrated in FIG. 6B may not be scalable, and cannot accommodate multiple RISs. In one example, including two RISs may not be applicable since the base station may reserve all eight SSB beams for transmitting two repetitions of the SSB beams towards the two RISs, and may not maintain the field of view for the SSB beam-sweeping process.

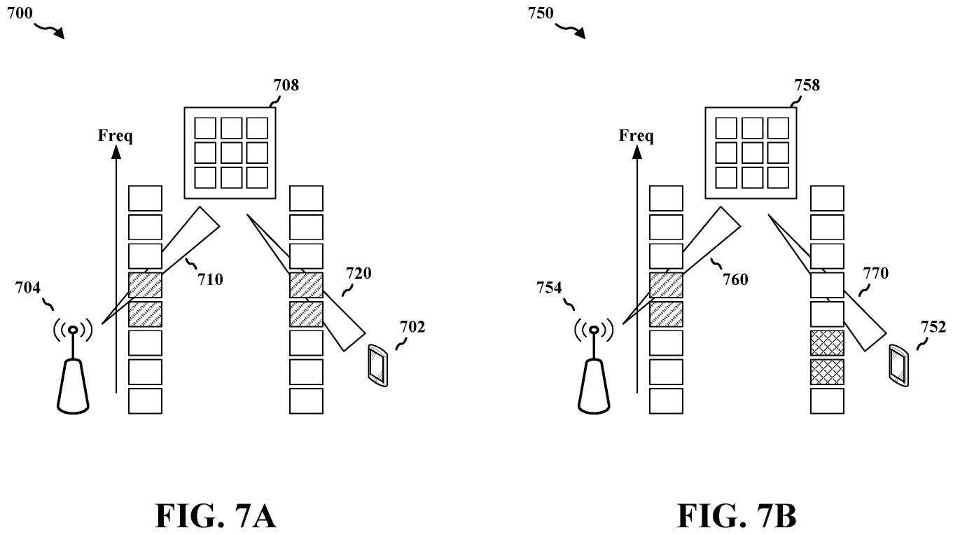

FIGS. 7A and 7B are examples of wireless communication with RIS. FIG. 7A may include a UE 702, a base station 704, and a RIS 708, and illustrate an example of wireless communication 700 without a water-marking via the RIS 708. Here, the first SSB beam 710 received from a base station 704 and the second SSB beam 720 reflected towards the UE 702 may have the same center frequency. For example, the configuration of the RIS 708 may be represented by the following formula: ϕ(t)=ϕ₀, where ϕ₀ may represent a controllable amplitude of the RIS 708. In one aspect, the RIS configuration may be configured as a constant value throughout a symbol duration.

Based on the example of wireless communication 700 without the water-marking via the RIS 708, it may be transparent for the base station 704 whether the UE 702 received the first SSB beam 710 from the base station 704 or the second SSB beam 720 via the RIS 708, and therefore, the base station 704 may not determine or distinguish whether the UE 702 is connected to the base station 704 via the RIS 708 or the direct link. The RIS may configure the base station by providing a watermarking procedure.

FIG. 7B may include a UE 752, a base station 754, and a RIS 758, and illustrate an example of wireless communication 750 with the water-marking via the RIS 758. By slowly changing the configuration of the RIS 758 over time, we can shift the reflected signal in the frequency domain. That is, the RIS 758 may apply a frequency shift to generate the second SSB beam 770 from the first SSB beam, and the first SSB beam 760 received from a base station 754 and the second SSB beam 770 reflected towards the UE 752 may have different center frequencies. For example, the configuration of the RIS 758 may be represented by the following formula: ϕ(t)=ϕ₀×e^{j2πf}^{₀}^{t}, where ϕ₀ may represent the controllable amplitude of the RIS 758 and the e^{j2πf}^{₀}^{t} may represent the phase a sinusoid function that applies the frequency shift. In one aspect, the RIS configuration may change according to the sinusoid function.

The base station 754 may light up the RIS 758, and the RIS 758 may add its water-marking to the first SSB beam 760 to generate the second SSB beam 770. Accordingly, the base station 754 may configure the RIS 758 with a new sync raster associated with the water-marking, and the RIS 758 may apply the phase shifting to the first SSB beam 760 associated with a first sync raster. The second SSB beam 770 generated by the RIS 758 may be associated with the new sync raster, where the new sync raster is generated by phase shifting the first sync raster of the first SSB beam 760.

For one example, water-marking may transfer the SSB beam to a different center frequency. For instance, the first sync raster of the first SSB beam 760 may be associated, e.g., based on a 5G NR global synchronization channel number (GSCN), with the synchronization signal center frequency via 2400 MHZ+N·1.44 MHZ, the new sync raster of the second SSB beam 770 may be identified as 2400.36 MHZ+N·1.44 MHz or 2399.64 MHz+N·1.44 MHz. That is, the RIS 758 may be configured to apply a phase shift of +0.36 MHz to the first SSB beam 760 received from the base station to generate the second SSB beam 770 reflected to the UE 752. The UE 752 may monitor both sync rasters, e.g., the first sync raster associated with the first SSB beam 760 and the new sync raster associated with the second SSB beam 770, to find the strongest beam. The UE 752 will report the most suitable beam, e.g., the strongest beam, in a time domain and the sync raster in a frequency domain associated with the most suitable beam.

Accordingly, the UE 752 may detect whether the UE 752 is connected to the base station via the RIS 758 or via the direct link from the base station 754. The base station 754 may configure the RIS with the selected beam, based on the UE 752 selecting the new sync raster associated with the second SSB beam 770.

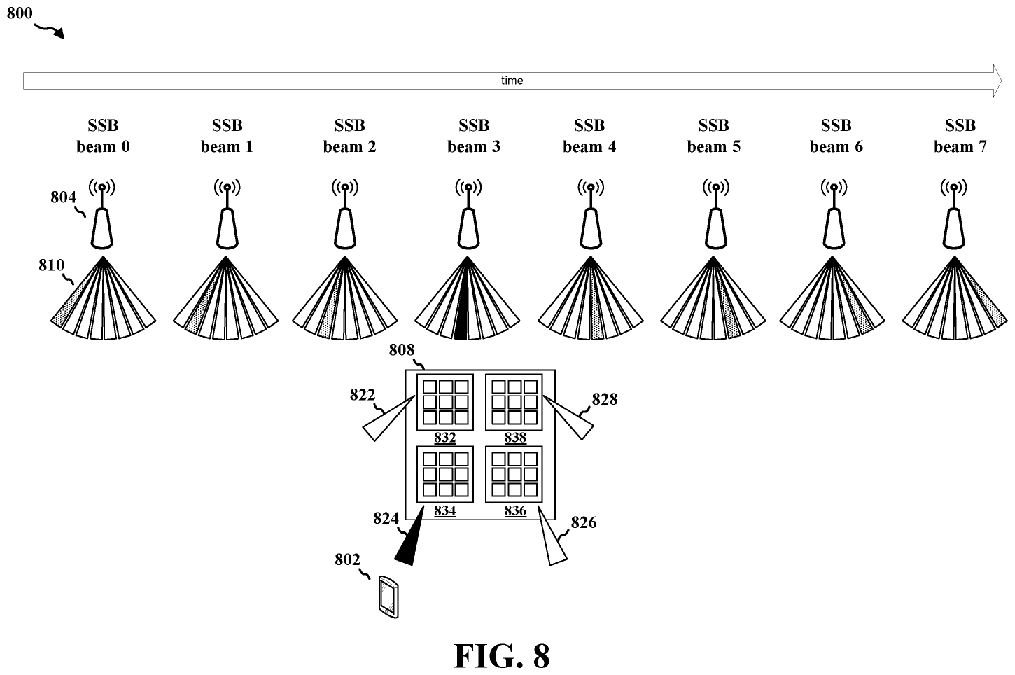

FIG. 8 is an example of beam-sweeping 800 including a RIS 808. The example of beam-sweeping 800 may include a UE 802, a base station 804, and the RIS 808. The base station 804 may transmit the SSBs on different beams in different directions in the TDM fashion. That is, the base station 804 may be configured to transmit multiple SSBs, where the multiple SSBs may be transmitted on different SSB beams 810 sequentially in different directions. In one example, the base station 804 may be configured to transmit eight (8) SSBs on eight (8) SSB beams in eight (8) different directions. Here, the RIS 808 may be located in a direction associated with a fourth SSB beam of the multiple SSB beams 810.

The RIS 808 may not include a digital-to-analog converter (DAC), a mixer, or a radio frequency (RF) chain attached to its elements. Therefore, it may be cheaper to build the RIS 808 in a bigger size with a relatively more complicated configuration, compared to building an active antenna unit with a similar functionality.

In some aspects, the RIS may be divided into multiple sub-RISs, where each sub-RIS of the multiple sub-RISs may add different water-markings while reflecting the incident signal in different directions. That is, the RIS may include multiple sub-RISs, and the multiple sub-RISs may be configured to simultaneously apply different water-markings and reflect the incident beam into different beams in different directions simultaneously. For example, the RIS 808 may include a first sub-RIS 832, a second sub-RIS 834, a third sub-RIS 836, and a fourth sub-RIS 838. The first sub-RIS 832 may be configured to apply a first frequency shift f₀ and reflect the fourth SSB beam to a first reflected SSB beam 822 in a first direction. The second sub-RIS 834 may be configured to apply a frequency shift f₁ and reflect the fourth SSB beam to a second reflected SSB beam 824 in a second direction. The third sub-RIS 836 may be configured to apply a frequency shift f₂ and reflect the fourth SSB beam to a third reflected SSB beam 826 in a third direction. The fourth sub-RIS 838 may be configured to apply a frequency shift f₃ and reflect the fourth SSB beam to a fourth reflected SSB beam 828 in a fourth direction.

The first reflected SSB beam 822, the second reflected SSB beam 824, the third reflected SSB beam 826, and the fourth reflected SSB beam 828 may be associated with different sync rasters, e.g., multiple RIS sync rasters. Accordingly, the UE 802 may be configured to monitor a base sync raster associated with the multiple SSB beams 810 transmitted by the base station and the four (4) RIS sync rasters associated with the four reflected SSB beams 822, 824, 826, and 828 in the time-domain and the frequency-domain. The UE may report, to the base station, the most suitable beam index, e.g., the strongest beam index, and the corresponding sync raster. For example, the base sync raster may be associated with center frequencies of 2400 MHZ+N·1.44 MHZ.

In one example, the first sub-RIS 832 may be configured with the first RIS sync raster including first center frequencies of 2400.36+N·1.44 MHz. That is, the first RIS sync raster may include the first center frequencies of 2400+0.36+N·1.44 MHz. The SSB transmitted on the first reflected SSB beam 822 may be associated with the first RIS sync raster. Accordingly, the first sub-RIS 832 may be configured to perform the water-marking on the fourth SSB beam received from the base station 804 to transmit the first reflected SSB beam 822 in a first direction, the SSB on the first reflected SSB beam 822 may be associated with the first RIS sync raster including the first center frequencies of 2400+0.36+N·1.44 MHz.

In another example, the second sub-RIS 834 may be configured with the second RIS sync raster including second center frequencies of 2400.72+N·1.44 MHz. That is, the second RIS sync raster may include the second center frequencies of 2400+0.36·2+N·1.44 MHz. The SSB transmitted on the second reflected SSB beam 824 may be associated with the second RIS sync raster. Accordingly, the second sub-RIS 834 may be configured to perform the water-marking on the fourth SSB beam received from the base station 804 to transmit the second reflected SSB beam 824 in a second direction, the SSB on the second reflected SSB beam 824 may be associated with the second RIS sync raster including the second center frequencies of 2400+0.36·2+N·1.44 MHZ.

In another example, the third sub-RIS 836 may be configured with the third RIS sync raster including third center frequencies of 2399.64+N·1.44 MHz. That is, the third RIS sync raster may include the third center frequencies of 2400−0.36+N·1.44 MHz. The SSB transmitted on the third reflected SSB beam 826 may be associated with the third RIS sync raster. Accordingly, the third sub-RIS 836 may be configured to perform the water-marking on the fourth SSB beam received from the base station 804 to transmit the third reflected SSB beam 826 in a third direction, the SSB on the third reflected SSB beam 826 may be associated with the third RIS sync raster including the third center frequencies of 2400−0.36+N. 1.44 MHZ.

In another example, the fourth sub-RIS 838 may be configured with the fourth RIS sync raster including fourth center frequencies of 2399.36+N·1.44 MHz. That is, the fourth RIS sync raster may include the fourth center frequencies of 2400−0.36·2+N·1.44 MHz. The SSB transmitted on the fourth reflected SSB beam 828 may be associated with the fourth RIS sync raster. Accordingly, the fourth sub-RIS 838 may be configured to perform the water-marking on the fourth SSB beam received from the base station 804 to transmit the fourth reflected SSB beam 828 in a fourth direction, the SSB on the fourth reflected SSB beam 828 may be associated with the fourth RIS sync raster including the fourth center frequencies of 2400−0.36.2+N·1.44 MHZ.

In some aspects, the base station 804 may avoid reserving several beams for repetitions to allow the RIS 808 to perform beam-sweeping, and the base station 804 may avoid configuring wider beams to cover its field of view.

The UE 802 may be configured with a number of sync rasters including the multiple RIS sync rasters to monitor simultaneously. The UE 802 may be configured with the center frequency for each RIS sync raster of the multiple RIS sync rasters. For example, the UE 802 may be configured with the base sync raster including the center frequencies of 2400+N·1.44 MHz, the first RIS sync raster including the first center frequencies of 2400+0.36+N·1.44 MHz, the second RIS sync raster including the second center frequencies of 2400+0.36.2+N·1.44 MHZ, the third RIS sync raster including the third center frequencies of 2400-0.36+N·1.44 MHZ, and the fourth RIS sync raster including the fourth center frequencies of 2400-0.36.2+N·1.44 MHZ.

In some aspects, the UE 802 may be located in a direction associated with the second reflected SSB beam 824. The UE 802 may determine that the second reflected SSB beam 824 is the most suitable beam based on at least one measurement. The UE 802 may also detect that the second reflected SSB beam 824 corresponds to the fourth SSB beam of the multiple SSB beams 810 reflected by the second sub-RIS 834 based on second RIS sync raster associated with the second reflected SSB beam 824. That is, the UE 802 may detect that the second reflected SSB beam 824 is generated by the second sub-RIS 834 based on detecting that the SSB on the second reflected SSB beam 824 is associated with the second RIS sync raster including the second center frequencies of 2400+0.36-2+N·1.44 MHZ.

The UE may transmit a feedback report to the base station indicating the most suitable beam is the fourth SSB beam reflected to the second reflected SSB beam 824 by the second sub-RIS 834. Accordingly, the base station may configure the RIS 808 based on the feedback report received from the base station for beam management.

In another aspect, the UE 802 may not be configured with the RIS sync raster by the base station 804. The UE 802 may observe that the most suitable beam, e.g., the strongest beam received, is associated with on a sync raster that is not configured by the base station 804, and determine that the most suitable beam was received via a RIS. Accordingly, the UE 802 may send an indication of the RIS, e.g., a RIS presence indication, to the base station 804 to inform the base station 804 of the presence of the RIS 808 in the network.

In one aspect, the base station 804 may not be aware of the location of the RIS 808. That is, the UE 802 may detect the presence of the RIS 808 based on the sync raster of the SSB received in the SSB beams, and the base station 804 may understand the presence of the RIS 808 based on the feedback report received from the UE 802. Accordingly, the beam planning is not directly impacted or affected by the location of the RIS 808.

In another aspect, the base station 804 may be aware of the location of the RIS 808. Accordingly, the base station 804 may reduce the workload for the UE 802 by transmitting, to the UE 802, the information of when, e.g., which beam or which slot, to monitor for the RIS sync raster. That is, the base station 804 may transmit the configuration of a set of time resources that the base station 804 is beam-forming towards the RIS 808, and the UE 802 may be configured to monitor for the RIS sync raster during the configured set of time resources. Accordingly, the UE 802 may monitor the RIS sync raster during the configured set of time resources that the base station 804 is beam-forming towards the RIS 808, and the base sync raster in the rest of the time resources.

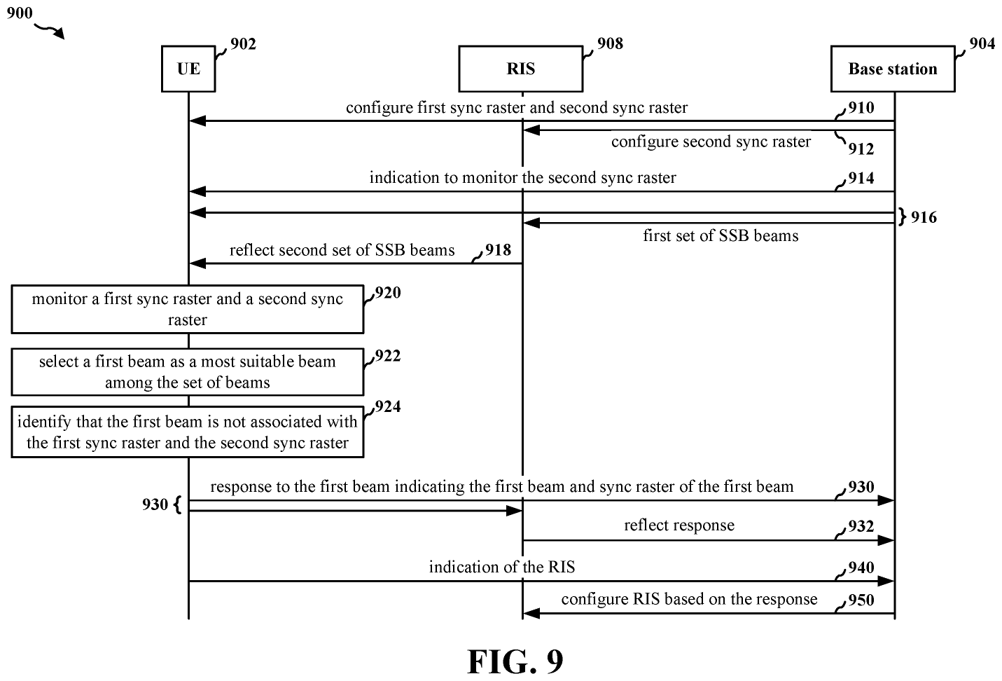

FIG. 9 is a call-flow diagram 900 of a method of wireless communication. The call-flow diagram 900 may include a UE 902, a base station 904, and a RIS 908. The RIS 908 may include multiple sub-RIS, and the base station 904 may configure the RIS 908 and the multiple sub-RIS with RIS sync raster including multiple center frequencies. The RIS 908 may be configured to simultaneously apply different water-markings and reflect the incident beam into different beams in different directions simultaneously. The base station 904 may perform a beam-sweeping by transmitting SSB on multiple SSB beams, and the RIS 908 may receive one SSB beam of the multiple SSB beams and transmit reflected SSB beams associated with the RIS sync raster. The UE 902 may be configured to monitor the base sync raster and the RIS sync raster for a suitable SSB beam, and transmit a feedback report to the base station 904 indicating the suitable beam. The base station 904 may configure the RIS 908 based on the feedback report received from the base station 904 for beam management.

At 910, the base station 904 may transmit, to the UE 902, a configuration of a first sync raster associated with the first set of beams and the second sync raster associated with the second set of beams reflected at the RIS 908. The UE 902 may receive, from the base station 904, a configuration of a first sync raster associated with the first set of beams and the second sync raster associated with the second set of beams reflected at the RIS 908. In some aspects, the first sync raster may refer to the base sync raster for the base station 904, and the first sync raster may include a first set of center frequencies.

At 912, the base station 904 may transmit, to the RIS 908, a configuration of a second sync raster for the RIS 908 to reflect a first beam into a second set of beams, the second set of beams being associated with the second sync raster. The RIS 908 may receive, from the base station 904, a configuration of the second sync raster. In one aspect, the second sync raster may refer to the RIS sync raster, and the second sync raster may include a second set of center frequencies.

At 914, the base station 904 may transmit, to the UE 902, an indication to monitor the second sync raster. The UE 902 may receive, from the base station 904, an indication to monitor the second sync raster. In one aspect, the base station 904 may be aware of the location of the RIS 908, and the base station 904 may reduce the workload for the UE 902 by transmitting, to the UE 902, the information of when, e.g., which beam or which slot, to monitor for the RIS sync raster. Here, the second sync raster may be monitored by the UE 902 at 920 for the second set of beams based on receiving the indication to monitor the second sync raster.

At 916, the base station 904 may transmit a first set of beams including the first beam, the first set of beams being associated with a first sync raster, each beam of the first set of beams being transmitted in different directions. The first set of beams may be broadcasted in a beam-sweeping configuration for an initial access procedure. The UE 902 or the RIS 908 may receive, from the base station 904, a first set of beams including the first beam, the first set of beams being associated with a first sync raster, each beam of the first set of beams being transmitted in different directions. In some aspects, the first sync raster may include a first set of center frequencies. Here, the base station 904 transmitting the first set of beams in different directions may be referred to as the SSB beam-sweeping at the base station 904.

At 918, the RIS 908 may reflect the first beam into a second set of beams associated with a second sync raster, the second set of beams being reflected simultaneously. The UE 902 may receive the second set of beams associated with a second sync raster reflected at the RIS 908, the second set of beams being received simultaneously. The RIS 908 may be divided into multiple sub-RISs, where each sub-RIS of the multiple sub-RISs may add different water-markings while reflecting the incident signal in different directions. That is, the RIS 908 including multiple sub-RISs may be configured to simultaneously apply different water-markings and reflect the incident beam into different beams in different directions simultaneously. In one aspect, the second sync raster may include a second set of center frequencies. In another aspect, the second set of center frequencies may be defined by shifting the first set of center frequencies by a RIS frequency offset.

At 920, the UE 902 may monitor the first sync raster and the sync raster for a set of beams including a second set of beams being simultaneously received and associated with the second sync raster, the first sync raster being associated with a first set of beams from a base station 904 and the second sync raster being associated with the second set of beams reflected at the RIS 908. In one aspect, the UE 902 may monitor the second sync raster during the configured set of time resources that the base station 904 is beam-forming towards the RIS 908 based on the indication to monitor the second sync raster at 914, and the base sync raster in the rest of the time resources.

At 922, the UE 902 may select a first beam of the set of beams, the first beam being a most suitable beam among the set of beams. That is, based on the first sync raster and the second sync raster, the UE 902 may detect and measure at least one beam from the first set of beams associated with the first sync raster and the second set of beams associated with the second sync raster, and determine or select the first beam as the most suitable beam based on at least one measurement of the first beam.

At 924, the UE 902 may identify that the first beam is not associated with the first sync raster and the second sync raster. That is, the UE 902 may identify that the most suitable beam, e.g., the strongest beam received, is associated with a sync raster that is not configured by the base station 904, and determine that the most suitable beam was received via a RIS 908. The UE 902 may send an indication of the RIS 908, e.g., a RIS 908 presence indication, to the base station 904 to inform the base station 904 of the presence of the RIS 908 (or another RIS not detected by the network) in the network at 940.

At 930, the UE 902 may transmit, to the base station 904 or the RIS 908, a response to the first beam indicating the first beam and a selected sync raster associated with the first beam. Here, the response may be transmitted via the first beam in a time-domain and the selected sync raster in a frequency-domain. The RIS 908 may receive, from the UE 902, a response to a third beam, the response indicating the third beam and a selected sync raster associated with the third beam. Here, the response may be received from the UE 902 with the third beam in a time-domain and the selected sync raster in a frequency-domain.

At 932, the RIS 908 may reflect the response associated with the third beam to the base station 904. The base station 904 may receive, from the UE 902 via the RIS 908, a response to a third beam, the response indicating the third beam and a selected sync raster associated with the third beam. Here, the response may be received from the UE 902 via the RIS 908 using the first beam.

At 940, the UE 902 may transmit, to the base station 904, an indication of the RIS 908 based on the first beam being not associated with the first sync raster and the second sync raster being configured by the base station 904. The base station 904 may receive, from the UE 902, an indication of the RIS 908 based on the first beam being not associated with the first sync raster and the second sync raster being configured by the base station 904. The UE 902 may identify, at 924, that the first beam is not associated with the first sync raster and the second sync raster, and send an indication of the RIS 908, e.g., a RIS presence indication, to the base station 904 to inform the base station 904 of the presence of the RIS 908 in the network.

At 950, the base station 904 may configure the RIS 908 based on the feedback report received from the UE 902 for beam management. The RIS 908 may receive, from the base station 904, a configuration of the RIS 908 based on the feedback report received from the UE 902 for beam management. Accordingly, even if there is a blockage between the base station 904 and the UE 902, the base station may configure the RIS 908 to change the direction of the beam towards the UE 902 for better wireless communication.

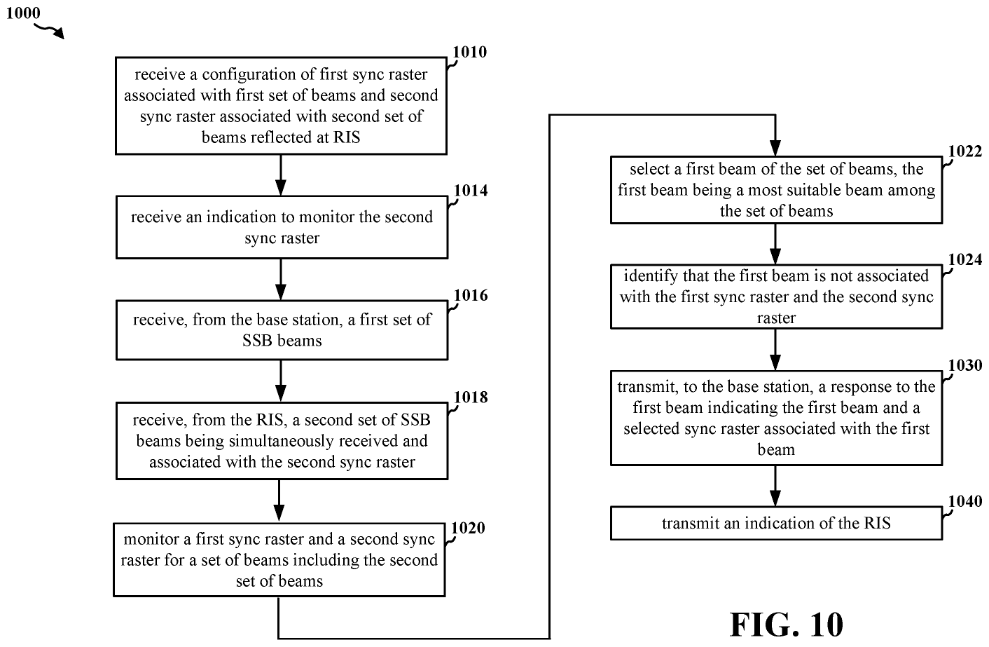

FIG. 10 is a flowchart 1000 of a method of wireless communication. The method may be performed by a UE (e.g., the UE 104/802/902; the apparatus 1602). The UE may be configured to monitor the base sync raster and the RIS sync raster for a suitable SSB beam, and transmit a feedback report to the base station indicating the suitable beam.

At 1010, the UE may receive, from the base station, a configuration of a first sync raster associated with the first set of beams and the second sync raster associated with the second set of beams reflected at the RIS. In some aspects, the first sync raster may refer to the base sync raster for the base station, and the first sync raster may include a first set of center frequencies. For example, at 910, the UE 902 may receive, from the base station 904, a configuration of a first sync raster associated with the first set of beams and the second sync raster associated with the second set of beams reflected at the RIS 908. Furthermore, 1010 may be performed by a sync raster configuring component 1640.

At 1014, the UE may receive, from the base station, an indication to monitor the second sync raster. In one aspect, the base station may be aware of the location of the RIS, and the base station may reduce the workload for the UE by transmitting, to the UE, the information of when, e.g., which beam or which slot, to monitor for the RIS sync raster. Here, the second sync raster may be monitored by the UE at 1020 for the second set of beams based on receiving the indication to monitor the second sync raster. For example, at 914, the UE 902 may receive, from the base station 904, an indication to monitor the second sync raster. Furthermore, 1014 may be performed by the sync raster configuring component 1640.

At 1016, the UE may receive, from the base station, a first set of beams including the first beam, the first set of beams being associated with a first sync raster, each beam of the first set of beams being transmitted in different directions. In some aspects, the first sync raster may include a first set of center frequencies. Here, the base station transmitting the first set of beams in different directions may be referred to as the SSB beam-sweeping at the base station. For example, at 916, the UE 902 may receive, from the base station 904, a first set of beams including the first beam. Furthermore, 1016 may be performed by an SSB beam component 1642.

At 1018, the UE may receive the second set of beams associated with a second sync raster reflected at the RIS, the second set of beams being received simultaneously. The RIS may be divided into multiple sub-RISs, where each sub-RIS of the multiple sub-RISs may add different water-markings while reflecting the incident signal in different directions. That is, the RIS including multiple sub-RISs may be configured to simultaneously apply different water-markings and reflect the incident beam into different beams in different directions simultaneously. In one aspect, the second sync raster may include a second set of center frequencies. In another aspect, the second set of center frequencies may be defined by shifting the first set of center frequencies by a RIS frequency offset. For example, at 918, the UE 902 may receive the second set of beams associated with a second sync raster reflected at the RIS 908, the second set of beams being received simultaneously. Furthermore, 1018 may be performed by the SSB beam component 1642.

At 1020, the UE may monitor the first sync raster and the sync raster for a set of beams including a second set of beams being simultaneously received and associated with the second sync raster, the first sync raster being associated with a first set of beams from a base station and the second sync raster being associated with the second set of beams reflected at the RIS. In one aspect, the UE may monitor the second sync raster during the configured set of time resources that the base station is beam-forming towards the RIS based on the indication to monitor the second sync raster at 1014, and the base sync raster in the rest of the time resources. For example, at 920, the UE 902 may monitor the first sync raster and the sync raster for a set of beams including a second set of beams being simultaneously received and associated with the second sync raster, the first sync raster being associated with a first set of beams from a base station 904 and the second sync raster being associated with the second set of beams reflected at the RIS 908. Furthermore, 1020 may be performed by the SSB beam component 1642.

At 1022, the UE may select a first beam of the set of beams, the first beam being a most suitable beam among the set of beams. That is, based on the first sync raster and the second sync raster, the UE may detect and measure at least one beam from the first set of beams associated with the first sync raster and the second set of beams associated with the second sync raster, and determine or select the first beam as the most suitable beam based on at least one measurement of the first beam. For example, at 922, the UE 902 may select a first beam of the set of beams, the first beam being a most suitable beam among the set of beams. Furthermore, 1022 may be performed by a suitable beam selecting component 1644.

At 1024, the UE may identify that the first beam is not associated with the first sync raster and the second sync raster. That is, the UE may identify that the most suitable beam, e.g., the strongest beam received, is associated with a sync raster that is not configured by the base station, and determine that the most suitable beam was received via a RIS. The UE may send an indication of the RIS, e.g., a RIS presence indication, to the base station to inform the base station of the presence of the RIS 908 (or another RIS not detected by the network) in the network at 1040. For example, at 924, the UE 902 may identify that the first beam is not associated with the first sync raster and the second sync raster. Furthermore, 1024 may be performed by a RIS identifying component 1646.

At 1030, the UE may transmit, to the base station 904, a response to the first beam indicating the first beam and a selected sync raster associated with the first beam. Here, the response may be transmitted via the first beam in a time-domain and the selected sync raster in a frequency-domain. For example, at 930, the UE 902 may transmit, to the base station 904, a response to the first beam indicating the first beam and a selected sync raster associated with the first beam. Furthermore, 1030 may be performed by a beam feedback response component 1648.

At 1040, the UE may transmit, to the base station, an indication of the RIS based on the first beam being not associated with the first sync raster and the second sync raster being configured by the base station. The UE may identify, at 1024, that the first beam is not associated with the first sync raster and the second sync raster, and send an indication of the RIS, e.g., a RIS presence indication, to the base station to inform the base station of the presence of the RIS in the network. For example, at 940, the UE 902 may transmit, to the base station 904, an indication of the RIS 908 based on the first beam being not associated with the first sync raster and the second sync raster being configured by the base station 904. Furthermore, 1040 may be performed by the RIS identifying component 1646.

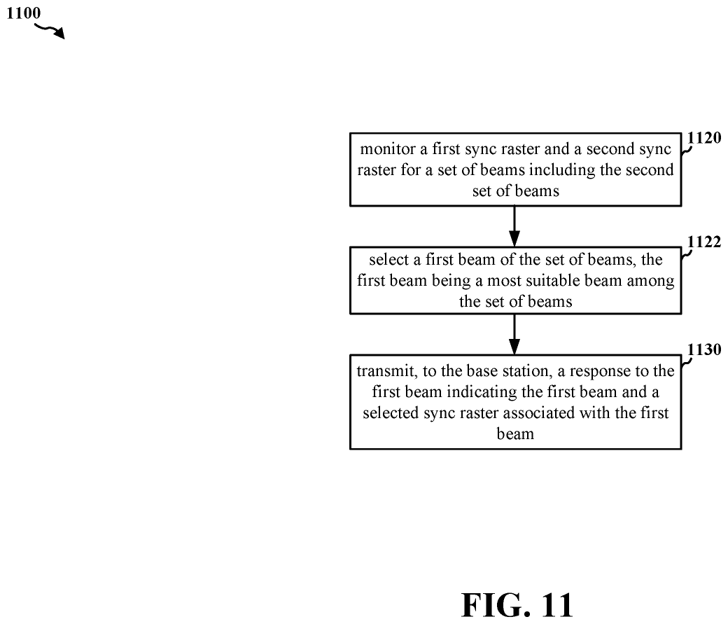

FIG. 11 is a flowchart 1100 of a method of wireless communication. The method may be performed by a UE (e.g., the UE 114/802/902; the apparatus 1602). The UE may be configured to monitor the base sync raster and the RIS sync raster for a suitable SSB beam, and transmit a feedback report to the base station indicating the suitable beam.

At 1120, the UE may monitor the first sync raster and the sync raster for a set of beams including a second set of beams being simultaneously received and associated with the second sync raster, the first sync raster being associated with a first set of beams from a base station and the second sync raster being associated with the second set of beams reflected at the RIS. In one aspect, the UE may monitor the second sync raster during the configured set of time resources that the base station is beam-forming towards the RIS based on the indication to monitor the second sync raster at 1114, and the base sync raster in the rest of the time resources. For example, at 920, the UE 902 may monitor the first sync raster and the sync raster for a set of beams including a second set of beams being simultaneously received and associated with the second sync raster, the first sync raster being associated with a first set of beams from a base station 904 and the second sync raster being associated with the second set of beams reflected at the RIS 908. Furthermore, 1120 may be performed by the SSB beam component 1642.

At 1122, the UE may select a first beam of the set of beams, the first beam being a most suitable beam among the set of beams. That is, based on the first sync raster and the second sync raster, the UE may detect and measure at least one beam from the first set of beams associated with the first sync raster and the second set of beams associated with the second sync raster, and determine or select the first beam as the most suitable beam based on at least one measurement of the first beam. For example, at 922, the UE 902 may select a first beam of the set of beams, the first beam being a most suitable beam among the set of beams. Furthermore, 1122 may be performed by a suitable beam selecting component 1644.

At 1130, the UE may transmit, to the base station 904, a response to the first beam indicating the first beam and a selected sync raster associated with the first beam. Here, the response may be transmitted via the first beam in a time-domain and the selected sync raster in a frequency-domain. For example, at 930, the UE 902 may transmit, to the base station 904, a response to the first beam indicating the first beam and a selected sync raster associated with the first beam. Furthermore, 1130 may be performed by a beam feedback response component 1648.

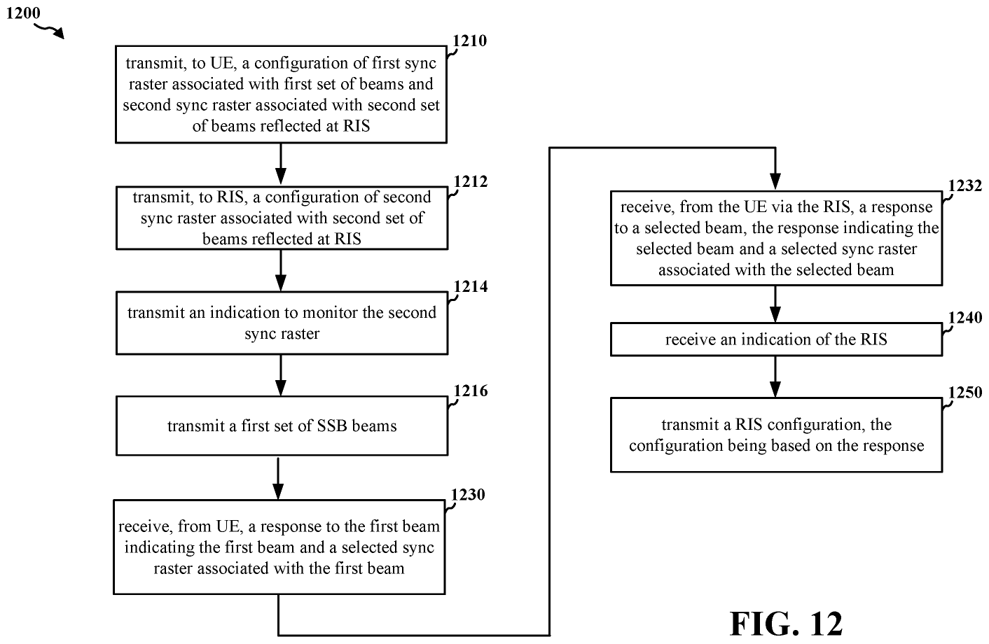

FIG. 12 is a flowchart 1200 of a method of wireless communication. The method may be performed by a base station (e.g., the base station 102/180; the apparatus 1702). The base station may configure a RIS including multiple sub-RIS to simultaneously apply different water-markings and reflect the incident beam into different beams in different directions simultaneously. The base station may perform a beam-sweeping by transmitting SSB on multiple SSB beams and receive a feedback report from the UE indicating the suitable beam. The base station may configure the RIS based on the feedback report received from the base station for beam management.

At 1210, the base station may transmit, to the UE, a configuration of a first sync raster associated with the first set of beams and the second sync raster associated with the second set of beams reflected at the RIS. In some aspects, the first sync raster may refer to the base sync raster for the base station, and the first sync raster may include a first set of center frequencies. For example, at 910, the base station 904 may transmit, to the UE 902, a configuration of a first sync raster associated with the first set of beams and the second sync raster associated with the second set of beams reflected at the RIS 908. Furthermore, 1210 may be performed by a sync raster component 1740.

At 1212, the base station may transmit, to the RIS, a configuration of a second sync raster for the RIS to reflect a first beam into a second set of beams, the second set of beams being associated with the second sync raster. In one aspect, the second sync raster may refer to the RIS sync raster, and the second sync raster may include a second set of center frequencies. For example, at 912, the base station 904 may transmit, to the RIS 908, a configuration of a second sync raster for the RIS 908 to reflect a first beam into a second set of beams, the second set of beams being associated with the second sync raster. Furthermore, 1212 may be performed by the sync raster component 1740.

At 1214, the base station may transmit, to the UE, an indication to monitor the second sync raster. In one aspect, the base station may be aware of the location of the RIS, and the base station may reduce the workload for the UE by transmitting, to the UE, the information of when, e.g., which beam or which slot, to monitor for the RIS sync raster. In one aspect, the base station may be aware of the location of the RIS, and the base station may reduce the workload for the UE by transmitting, to the UE, the information of when, e.g., which beam or which slot, to monitor for the RIS sync raster. Here, the second sync raster may be monitored by the UE at 1220 for the second set of beams based on receiving the indication to monitor the second sync raster. For example, at 914, the base station 904 may transmit, to the UE 902, an indication to monitor the second sync raster. Furthermore, 1214 may be performed by the sync raster component 1740.

At 1216, the base station may transmit a first set of beams including the first beam, the first set of beams being associated with a first sync raster, each beam of the first set of beams being transmitted in different directions. The first set of beams may be broadcasted in a beam-sweeping configuration for an initial access procedure. In some aspects, the first sync raster may include a first set of center frequencies. Here, the base station transmitting the first set of beams in different directions may be referred to as the SSB beam-sweeping at the base station. For example, at 916, the base station 904 may transmit, to the UE 902 and the RIS 908, a first set of beams including the first beam. Furthermore, 1216 may be performed by an SSB beam component 1742.

At 1230, the base station may receive, from the UE, a response to the first beam indicating the first beam and a selected sync raster associated with the first beam.

Here, the response may be transmitted via the first beam in a time-domain and the selected sync raster in a frequency-domain. For example, at 930, the base station 904 may receive, from the UE 902, a response to the first beam indicating the first beam and a selected sync raster associated with the first beam. Furthermore, 1230 may be performed by a suitable beam selecting component 1744.

At 1232, the base station may receive, from the UE via the RIS, a response to a third beam, the response indicating the third beam and a selected sync raster associated with the third beam. Here, the response may be received from the UE via the RIS 908 using the first beam. For example, at 932, the base station 904 may receive, from the UE 902 via the RIS 908, a response to a third beam, the response indicating the third beam and a selected sync raster associated with the third beam. Furthermore, 1232 may be performed by the suitable beam selecting component 1744.

At 1240, the base station may receive, from the UE, an indication of the RIS based on the first beam being not associated with the first sync raster and the second sync raster being configured by the base station. The UE may identify that the first beam is not associated with the first sync raster and the second sync raster, and send an indication of the RIS, e.g., a RIS presence indication, to the base station to inform the base station 904 of the presence of the RIS in the network. For example, at 940, the base station 904 may receive, from the UE 902, an indication of the RIS 908 based on the first beam being not associated with the first sync raster and the second sync raster being configured by the base station 904. Furthermore, 1240 may be performed by a RIS identifying component 1746.

At 1250, the base station may configure the RIS based on the feedback report received from the UE for beam management. Accordingly, even if there is a blockage between the base station and the UE, the base station may configure the RIS to change the direction of the beam towards the UE for better wireless communication. For example, at 950, the base station 904 may configure the RIS 908 based on the feedback report received from the UE 902 for beam management. Furthermore, 1250 may be performed by a RIS configuring component 1748.

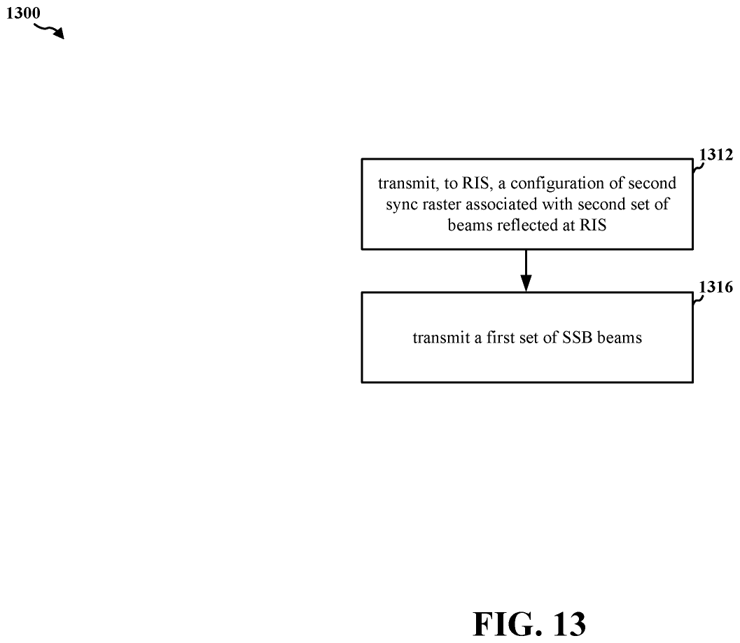

FIG. 13 is a flowchart 1300 of a method of wireless communication. The method may be performed by a base station (e.g., the base station 102/180; the apparatus 1702). The base station may configure a RIS including multiple sub-RIS to simultaneously apply different water-markings and reflect the incident beam into different beams in different directions simultaneously. The base station may perform a beam-sweeping by transmitting SSB on multiple SSB beams and receive a feedback report from the UE indicating the suitable beam. The base station may configure the RIS based on the feedback report received from the base station for beam management.

At 1312, the base station may transmit, to the RIS, a configuration of a second sync raster for the RIS to reflect a first beam into a second set of beams, the second set of beams being associated with the second sync raster. In one aspect, the second sync raster may refer to the RIS sync raster, and the second sync raster may include a second set of center frequencies. For example, at 912, the base station 904 may transmit, to the RIS 908, a configuration of a second sync raster for the RIS 908 to reflect a first beam into a second set of beams, the second set of beams being associated with the second sync raster. Furthermore, 1312 may be performed by the sync raster component 1740.

At 1316, the base station may transmit, to the UE and the RIS, a first set of beams including the first beam, the first set of beams being associated with a first sync raster, each beam of the first set of beams being transmitted in different directions. In some aspects, the first sync raster may include a first set of center frequencies. Here, the base station transmitting the first set of beams in different directions may be referred to as the SSB beam-sweeping at the base station. For example, at 916, the base station 904 may transmit, to the UE 902 and the RIS 908, a first set of beams including the first beam. Furthermore, 1316 may be performed by an SSB beam component 1742.

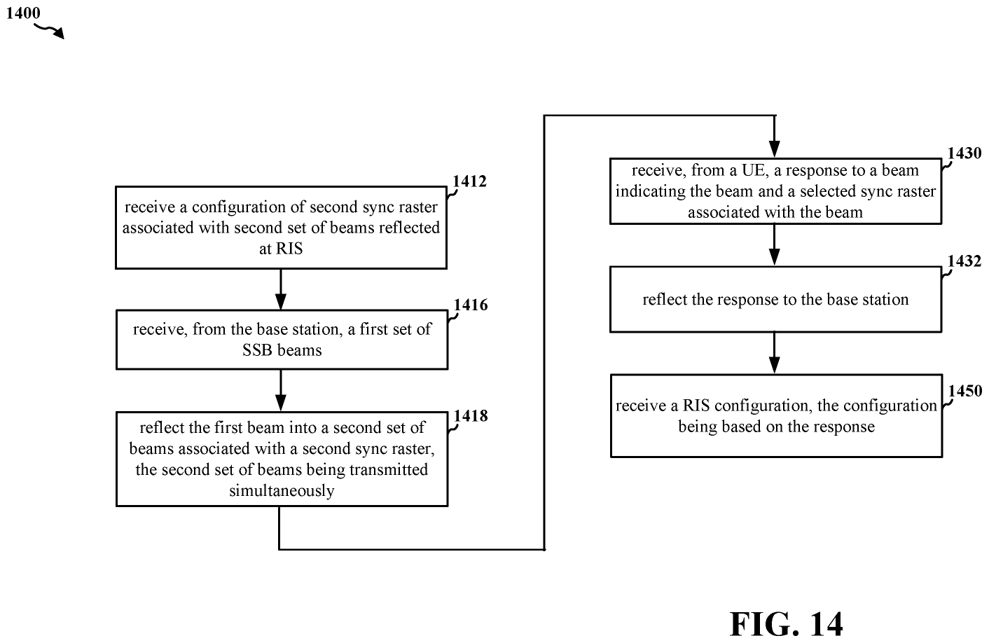

FIG. 14 is a flowchart 1400 of a method of wireless communication. The method may be performed by a RIS (e.g., the apparatus 1802). The RIS may include multiple sub-RIS, and the base station may configure the RIS and the multiple sub-RIS with RIS sync raster including multiple center frequencies. The RIS may be configured to simultaneously apply different water-markings and reflect the incident beam into different beams in different directions simultaneously. The RIS may receive one SSB beam of the multiple SSB beams and transmit reflected SSB beams associated with the RIS sync raster. The RIS may receive, from the base station, a configuration based on the feedback report that the UE transmitted to the base station indicating the suitable beam detected by the UE.

At 1412, the RIS may receive, from the base station, a configuration of the second sync raster. In one aspect, the second sync raster may refer to the RIS sync raster, and the second sync raster may include a second set of center frequencies. For example, at 912, the RIS 908 may receive, from the base station 904, a configuration of the second sync raster. Furthermore, 1412 may be performed by a sync raster component 1840.

At 1416, the RIS may receive, from the base station, a first set of beams including the first beam, the first set of beams being associated with a first sync raster, each beam of the first set of beams being transmitted in different directions. In some aspects, the first sync raster may include a first set of center frequencies. Here, the base station transmitting the first set of beams in different directions may be referred to as the SSB beam-sweeping at the base station. For example, at 906, the RIS 908 may receive, from the base station 904, a first set of beams including the first beam. Furthermore, 1416 may be performed by an SSB beam component 1842.

At 1418, the RIS may reflect the first beam into a second set of beams associated with a second sync raster, the second set of beams being reflected simultaneously. The RIS may be divided into multiple sub-RISs, where each sub-RIS of the multiple sub-RISs may add different water-markings while reflecting the incident signal in different directions. That is, the RIS including multiple sub-RISs may be configured to simultaneously apply different water-markings and reflect the incident beam into different beams in different directions simultaneously. In one aspect, the second sync raster may include a second set of center frequencies. In another aspect, the second set of center frequencies may be defined by shifting the first set of center frequencies by a RIS frequency offset. For example, at 908, the RIS 908 may reflect the first beam into a second set of beams associated with a second sync raster, the second set of beams being reflected simultaneously. Furthermore, 1418 may be performed by the SSB beam component 1842.

At 1430, the RIS may receive, from the UE, a response to a third beam, the response indicating the third beam and a selected sync raster associated with the third beam. Here, the response may be received from the UE with the third beam in a time-domain and the selected sync raster in a frequency-domain. For example, at 930, the RIS 908 may receive, from the UE 902, a response to a third beam, the response indicating the third beam and a selected sync raster associated with the third beam. Furthermore, 1430 may be performed by the SSB beam component 1842.

At 1432, the RIS may reflect the response associated with the third beam to the base station. Here, the response may be received from the UE via the RIS using the first beam. For example, at 932, the RIS 908 may reflect the response associated with the third beam to the base station 904. Furthermore, 1432 may be performed by the SSB beam component 1842.

At 1450, the RIS may receive, from the base station, a configuration of the RIS based on the feedback report received from the UE for beam management. Accordingly, even if there is a blockage between the base station and the UE, the base station may configure the RIS to change the direction of the beam towards the UE for better wireless communication. For example, at 950, the RIS 908 may receive, from the base station 904, a configuration of the RIS 908 based on the feedback report received from the UE 902 for beam management. Furthermore, 1450 may be performed by a RIS configuring component 1848.

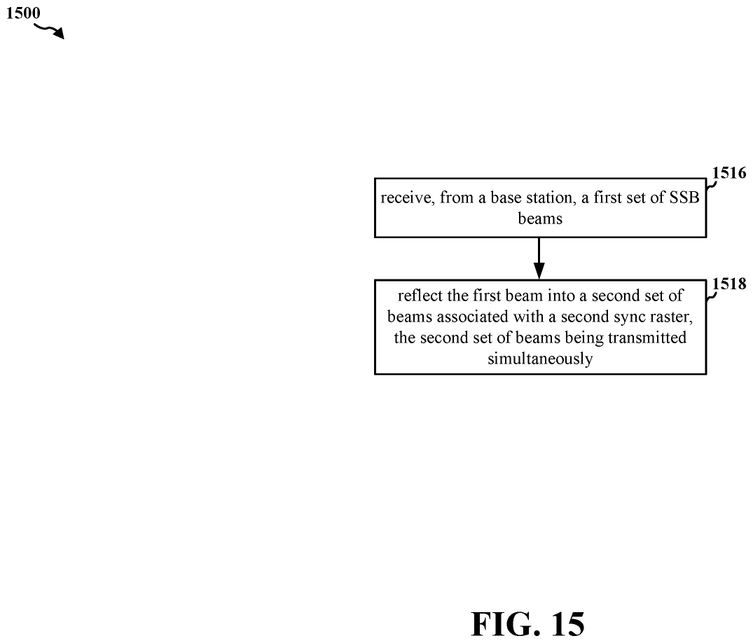

FIG. 15 is a flowchart 1500 of a method of wireless communication. The method may be performed by a RIS (e.g., the apparatus 1802). The RIS may include multiple sub-RIS, and the base station may configure the RIS and the multiple sub-RIS with RIS sync raster including multiple center frequencies. The RIS may be configured to simultaneously apply different water-markings and reflect the incident beam into different beams in different directions simultaneously. The RIS may receive one SSB beam of the multiple SSB beams and transmit reflected SSB beams associated with the RIS sync raster. The RIS may receive, from the base station, a configuration based on the feedback report that the UE transmitted to the base station indicating the suitable beam detected by the UE.

At 1516, the RIS may receive, from the base station, a first set of beams including the first beam, the first set of beams being associated with a first sync raster, each beam of the first set of beams being transmitted in different directions. In some aspects, the first sync raster may include a first set of center frequencies. Here, the base station transmitting the first set of beams in different directions may be referred to as the SSB beam-sweeping at the base station. For example, at 906, the RIS 908 may receive, from the base station 904, a first set of beams including the first beam. Furthermore, 1516 may be performed by an SSB beam component 1842.

At 1518, the RIS may reflect the first beam into a second set of beams associated with a second sync raster, the second set of beams being reflected simultaneously. The RIS may be divided into multiple sub-RISs, where each sub-RIS of the multiple sub-RISs may add different water-markings while reflecting the incident signal in different directions. That is, the RIS including multiple sub-RISs may be configured to simultaneously apply different water-markings and reflect the incident beam into different beams in different directions simultaneously. In one aspect, the second sync raster may include a second set of center frequencies. In another aspect, the second set of center frequencies may be defined by shifting the first set of center frequencies by a RIS frequency offset. For example, at 908, the RIS 908 may reflect the first beam into a second set of beams associated with a second sync raster, the second set of beams being reflected simultaneously. Furthermore, 1518 may be performed by the SSB beam component 1842.

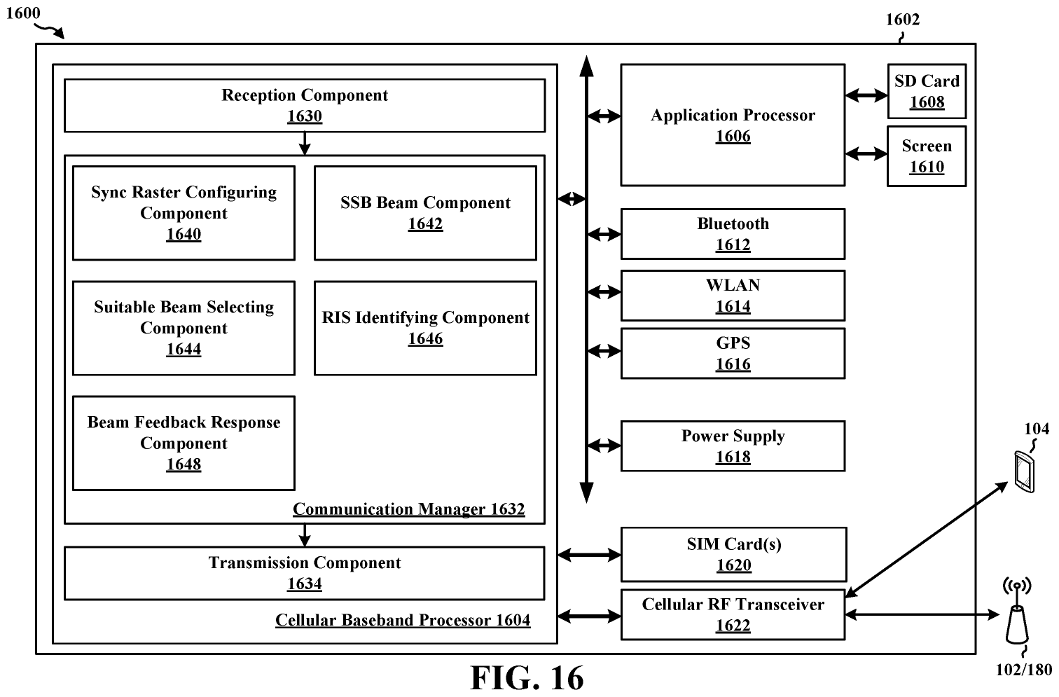

FIG. 16 is a diagram 1600 illustrating an example of a hardware implementation for an apparatus 1602. The apparatus 1602 may be a UE, a component of a UE, or may implement UE functionality. In some aspects, the apparatus 1602 may include a cellular baseband processor 1604 (also referred to as a modem) coupled to a cellular RF transceiver 1622. In some aspects, the apparatus 1602 may further include one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, or a power supply 1618. The cellular baseband processor 1604 communicates through the cellular RF transceiver 1622 with the UE 104 and/or base station 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the additional modules of the apparatus 1602.

The communication manager 1632 includes a sync raster configuring component 1640 that is configured to receive, from the base station, a configuration of a first sync raster and a second sync raster, and receive, from the base station, an indication to monitor the second sync raster, e.g., as described in connection with 1010 and 1014. The communication manager 1632 includes an SSB beam component 1642 that is configured to receive the second set of beams associated with a second sync raster or the first set of beams associated with the first sync raster, and monitor the first sync raster and the sync raster for a set of beams, e.g., as described in connection with 1016, 1018, 1020, and 1120. The communication manager 1632 includes a suitable beam selecting component 1644 that is configured to select a first beam of the set of beams, the first beam being a most suitable beam among the set of beams, e.g., as described in connection with 1022 and 1122. The communication manager 1632 includes a RIS identifying component 1646 that is configured to identify that the first beam is not associated with the first sync raster and the second sync raster, and transmit, to the base station, an indication of the RIS, e.g., as described in connection with 1024 and 1040. The communication manager 1632 includes a beam feedback response component 1648 that is configured to transmit, to the base station 904, a response to the first beam indicating the first beam and a selected sync raster associated with the first beam, e.g., as described in connection with 1030 and 1130.

The apparatus may include additional components that perform each of the blocks of the algorithm in the flowcharts of FIGS. 9, 10, and 11. As such, each block in the flowcharts of FIGS. 9, 10, and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the cellular baseband processor 1604, includes means for monitoring a first sync raster and a second sync raster for a set of beams including a second set of beams being simultaneously received and associated with the second sync raster, the first sync raster being associated with a first set of beams from a base station and the second sync raster being associated with the second set of beams reflected at a RIS, means for selecting a first beam of the set of beams, the first beam being a most suitable beam among the set of beams, and means for transmitting, to the base station, a response to the first beam indicating the first beam and a selected sync raster associated with the first beam. The apparatus 1602 includes means for identifying that the first beam is not associated with the first sync raster and the second sync raster, and means for transmitting, to the base station, an indication of the RIS based on the first beam being not associated with the first sync raster and the second sync raster being configured by the base station. The apparatus 1602 includes means for receiving, from the base station, a configuration of the first sync raster associated with the first set of beams and the second sync raster associated with the second set of beams reflected at the RIS. The apparatus 1602 includes means for receiving, from the base station, an indication to monitor the second sync raster. The means may be one or more of the components of the apparatus 1602 configured to perform the functions recited by the means. As described supra, the apparatus 1602 may include the TX Processor 368, the RX Processor 356, and the controller/processor 359. As such, in one configuration, the means may be the TX Processor 368, the RX Processor 356, and the controller/processor 359 configured to perform the functions recited by the means.

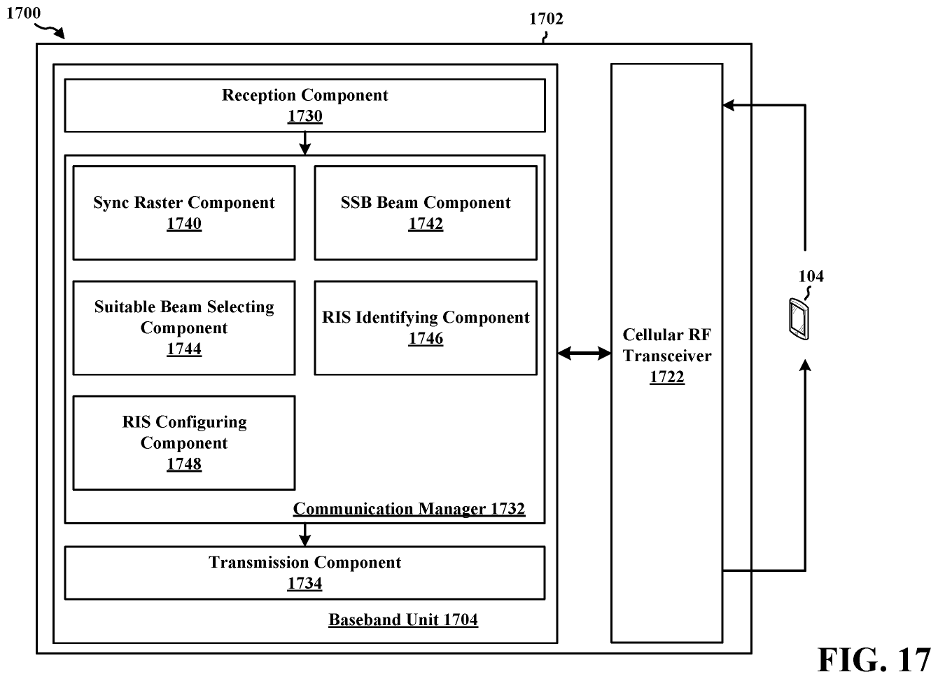

FIG. 17 is a diagram 1700 illustrating an example of a hardware implementation for an apparatus 1702. The apparatus 1702 may be a base station, a component of a base station, or may implement base station functionality. In some aspects, the apparatus 1602 may include a baseband unit 1704. The baseband unit 1704 may communicate through a cellular RF transceiver 1722 with the UE 104. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit 1704 may be a component of the base station 310 and may include the memory 376 and/or at least one of the TX processor 316, the RX processor 370, and the controller/processor 375.

The communication manager 1732 includes a sync raster component 1740 that is configured to transmit, to the UE, a configuration of a first sync raster and a second sync raster, transmit, to the RIS, a configuration of a second sync raster, and transmit, to the UE, an indication to monitor the second sync raster, e.g., as described in connection with 1210, 1212, 1214, and 1312. The communication manager 1732 includes an SSB beam component 1742 that is configured to transmit a first set of beams including the first beam, e.g., as described in connection with 1216 and 1316. The communication manager 1732 includes a suitable beam selecting component 1744 that is configured to receive, from the UE, a response to the first beam indicating the first beam and a selected sync raster associated with the first beam, and receive, from the UE via the RIS, a response to a third beam, the response indicating the third beam and a selected sync raster associated with the third beam, e.g., as described in connection with 1230 and 1232. The communication manager 1732 includes a RIS identifying component 1746 that is configured to receive, from the UE, an indication of the RIS, e.g., as described in connection with 1240. The communication manager 1732 includes a RIS configuring component 1748 that is configured to configure the RIS based on the feedback report received from the UE for beam management, e.g., as described in connection with 1250.

The apparatus may include additional components that perform each of the blocks of the algorithm in the flowcharts of FIGS. 9, 12, and 13. As such, each block in the flowcharts of FIGS. 9, 12, and 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the baseband unit 1704, includes means for transmitting, to a RIS, a configuration of a second sync raster for the RIS to reflect a first beam into a second set of beams, the second set of beams being associated with the second sync raster, and means for transmitting a first set of beams including the first beam, the first set of beams being associated with a first sync raster, each beam of the first set of beams being transmitted in different directions. The apparatus 1702 includes means for receiving, from the UE via the RIS, a response to a third beam, the response indicating the third beam and a selected sync raster associated with the third beam. The apparatus 1702 includes means for transmitting, to the UE, an indication to monitor the second sync raster. The means may be one or more of the components of the apparatus 1702 configured to perform the functions recited by the means. As described supra, the apparatus 1702 may include the TX Processor 316, the RX Processor 370, and the controller/processor 375. As such, in one configuration, the means may be the TX Processor 316, the RX Processor 370, and the controller/processor 375 configured to perform the functions recited by the means.

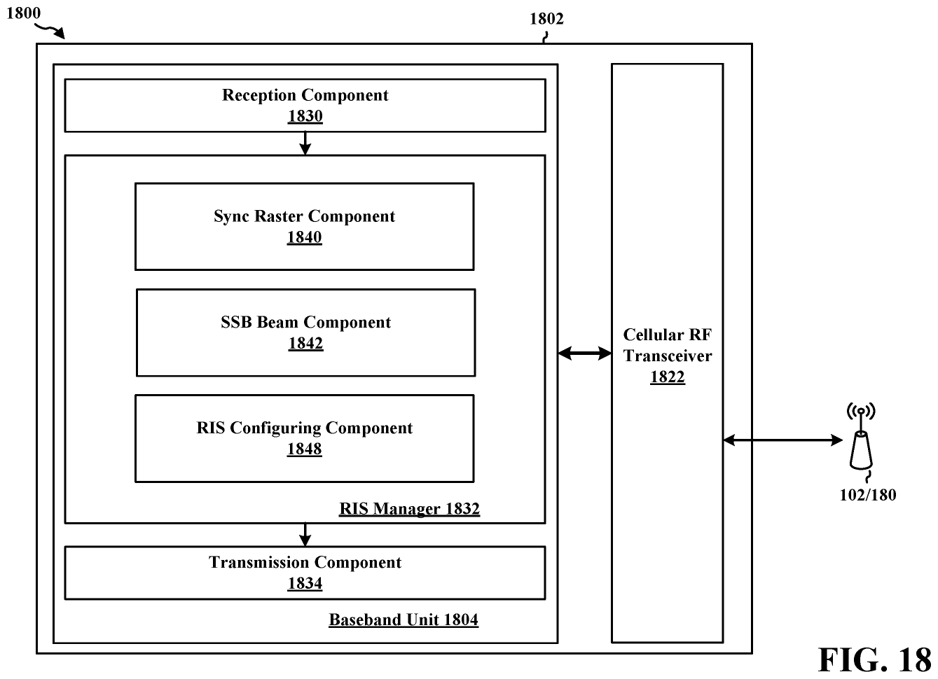

FIG. 18 is a diagram 1800 illustrating an example of a hardware implementation for an apparatus 1802. The apparatus 1802 may be a RIS or may implement RIS functionality. In some aspects, the apparatus 1602 may include a baseband unit 1804. The baseband unit 1804 may communicate through a cellular RF transceiver 1822 with the base station 102/180. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a RIS manager 1832, and a transmission component 1834. The RIS manager 1832 includes the one or more illustrated components. The components within the RIS manager 1832 may be stored in the computer-readable medium/memory and/or configured as hardware within the baseband unit 1804. The baseband unit 1804 may be a component of the base station 310 and may include the memory 376 and/or at least one of the TX processor 316, the RX processor 370, and the controller/processor 375.

The RIS manager 1832 includes a sync raster component 1840 that is configured to receive, from the base station, a configuration of the second sync raster, e.g., as described in connection with 1412. The RIS manager 1832 includes an SSB beam component 1842 that is configured to receive, from the base station, a first set of beams, reflect the first beam into a second set of beams associated with a second sync raster, receive, from the UE, a response to a third beam, reflect the response associated with the third beam to the base station, e.g., as described in connection with 1416, 1418, 1430, 1432, 1516, and 1518. The RIS manager 1832 includes a RIS configuring component 1848 that is configured to receive, from the base station, a configuration of the RIS based on the feedback report received from the UE for beam management, e.g., as described in connection with 1450.

The apparatus may include additional components that perform each of the blocks of the algorithm in the flowcharts of FIGS. 9, 14, and 15. As such, each block in the flowcharts of FIGS. 9, 14, and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the baseband unit 1804, includes means for receiving, from a base station, a first beam among a first set of beams associated with a first sync raster, and means for reflecting the first beam into a second set of beams associated with a second sync raster, the second set of beams being reflected simultaneously. The apparatus 1802 includes means for receiving, from the base station, a configuration of the second sync raster. The apparatus 1802 includes means for receiving, from a UE, a response to a third beam, the response indicating the third beam and a selected sync raster associated with the third beam, and means for reflecting the response associated with the reflected beam to the base station. The means may be one or more of the components of the apparatus 1802 configured to perform the functions recited by the means. As described supra, the apparatus 1802 may include the TX Processor 316, the RX Processor 370, and the controller/processor 375. As such, in one configuration, the means may be the TX Processor 316, the RX Processor 370, and the controller/processor 375 configured to perform the functions recited by the means.

A RIS may include multiple sub-RIS, and the base station may configure the RIS and the multiple sub-RIS with RIS sync raster including multiple center frequencies. The RIS may be configured to simultaneously apply different water-markings and reflect the incident beam into different beams in different directions simultaneously. The base station may perform a beam-sweeping by transmitting SSBs on multiple SSB beams, and the RIS may receive one SSB beam of the multiple SSB beams and transmit reflected SSB beams associated with the RIS sync raster. A UE may be configured to monitor the base sync raster and the RIS sync raster for a suitable SSB beam, and transmit a feedback report to the base station indicating the suitable beam. The base station may configure the RIS based on the feedback report received from the base station for beam management.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, including at least one processor coupled to a memory and configured to, based at least in part on information stored in the memory: monitor a first sync raster and a second sync raster for a set of beams including a second set of beams being simultaneously received and associated with the second sync raster, the first sync raster being associated with a first set of beams from a base station and the second sync raster being associated with the second set of beams reflected at a RIS, select a first beam of the set of beams, the first beam being a most suitable beam among the set of beams, and transmit, to the base station, a response to the first beam indicating the first beam and a selected sync raster associated with the first beam.

Aspect 2 is the apparatus of aspect 1, where the first set of beams and the second set of beams includes a plurality of SSBs.

Aspect 3 is the apparatus of any of aspects 1 and 2, where the response is transmitted via the first beam in a time-domain and the selected sync raster in a frequency-domain.

Aspect 4 is the apparatus of any of aspects 1 to 3, where the at least one processor is further configured to identify that the first beam is not associated with the first sync raster and the second sync raster, and transmit, to the base station, an indication of the RIS based on the first beam being not associated with the first sync raster and the second sync raster being configured by the base station.

Aspect 5 is the apparatus of any of aspects 1 to 4, where the at least one processor is further configured to receive, from the base station, a configuration of the first sync raster associated with the first set of beams and the second sync raster associated with the second set of beams reflected at the RIS.

Aspect 6 is the apparatus of any of aspects 1 to 5, where the first sync raster includes a first set of center frequencies and the second sync raster includes a second set of center frequencies, and where the second set of center frequencies is defined by shifting the first set of center frequencies by a RIS frequency offset.

Aspect 7 is the apparatus of any of aspects 1 to 6, where the at least one processor is further configured to receive, from the base station, an indication to monitor the second sync raster, where the second sync raster is monitored for the second set of beams based on receiving the indication to monitor the second sync raster.

Aspect 8 is a method of wireless communication for implementing any of aspects 1 to 7.

Aspect 9 is an apparatus for wireless communication including means for implementing any of aspects 1 to 7.

Aspect 10 is a computer-readable medium storing computer executable code, where the code when executed by a processor causes the processor to implement any of aspects 1 to 7.

Aspect 11 is an apparatus for wireless communication at a base station, including at least one processor coupled to a memory and configured to, based at least in part on information stored in the memory: transmit, to a RIS, a configuration of a second sync raster for the RIS to reflect a first beam into a second set of beams, the second set of beams being associated with the second sync raster, and transmit a first set of beams including the first beam, the first set of beams being associated with a first sync raster, each beam of the first set of beams being transmitted in different directions.

Aspect 12 is the apparatus of Aspect 11, where the first set of beams and the second set of beams include a plurality of SSBs.

Aspect 13 is the apparatus of any of aspects 11 and 12, where the first sync raster includes a first set of center frequencies and the second sync raster includes a second set of center frequencies, and where the second set of center frequencies is defined by shifting the first set of center frequencies by a RIS frequency offset.

Aspect 14 is the apparatus of any of aspects 11 to 13, where the at least one processor is further configured to receive, from the UE via the RIS, a response to a reflected beam, the response indicating the reflected beam and a selected sync raster associated with the third beam.

Aspect 15 is the apparatus of aspect 14, where the response is received from the UE via the RIS using the first beam.

Aspect 16 is the apparatus of any of aspects 11 to 15, where the at least one processor is further configured to transmit, to the UE, an indication to monitor the second sync raster, where the second sync raster is monitored for the second set of beams based on receiving the indication to monitor the second sync raster.

Aspect 17 is a method of wireless communication for implementing any of aspects 11 to 16.

Aspect 18 is an apparatus for wireless communication including means for implementing any of aspects 11 to 16.

Aspect 19 is a computer-readable medium storing computer executable code, where the code when executed by a processor causes the processor to implement any of aspects 11 to 16.

Aspect 20 is an apparatus for wireless communication at a RIS, including at least one processor coupled to a memory and configured to, based at least in part on information stored in the memory: receive, from a base station, a first beam among a first set of beams associated with a first sync raster, and reflect the first beam into a second set of beams associated with a second sync raster, the second set of beams being reflected simultaneously.

Aspect 21 is the apparatus of aspect 20, where the at least one processor is further configured to receive, from the base station, a configuration of the second sync raster.

Aspect 22 is the apparatus of any of aspects 20 and 21, where the first sync raster includes a first set of center frequencies and the second sync raster includes a second set of center frequencies, and where the second set of center frequencies is defined by shifting the first set of center frequencies by a RIS frequency offset.

Aspect 23 is the apparatus of any of aspects 20 to 22, where the first sync raster includes a first set of center frequencies and the second sync raster includes a second set of center frequencies, and where the second set of center frequencies is defined by shifting the first set of center frequencies by a RIS frequency offset.

Aspect 24 is the apparatus of any of aspects 20 to 23, where the at least one processor is further configured to: receive, from a UE, a response to a reflected beam, the response indicating the reflected beam and a selected sync raster associated with the reflected beam, and reflect the response associated to the base station.

Aspect 25 is the apparatus of aspect 24, where the response is received from the UE with the reflected beam in a time-domain and the selected sync raster in a frequency-domain.

Aspect 26 is the apparatus of any of aspects 20 to 25, where the response is reflected to the base station by the RIS.

Aspect 27 is the apparatus of any of aspects 20 to 26, further including a plurality of sub-RISs, where the plurality of sub-RISs is associated with the second sync raster and the first beam is reflected by the plurality of sub-RISs into the second set of beams associated with the second sync raster simultaneously.

Aspect 28 is a method of wireless communication for implementing any of aspects 20 to 27.

Aspect 29 is an apparatus for wireless communication including means for implementing any of aspects 20 to 27.

Aspect 30 is a computer-readable medium storing computer executable code, where the code when executed by a processor causes the processor to implement any of aspects 20 to 27.

What is claimed is:

1. An apparatus for wireless communication at a user equipment (UE), comprising:
a memory; and
at least one processor coupled to the memory and configured to, based at least in part on information stored in the memory:
monitor a first synchronization (sync) raster and a second sync raster for a set of beams including a second set of beams being simultaneously received and associated with the second sync raster, the first sync raster being associated with a first set of beams from a base station and the second sync raster being associated with the second set of beams reflected at a reconfigurable intelligent surface (RIS);
select a first beam of the set of beams, the first beam being a most suitable beam among the set of beams; and
transmit, to the base station, a response to the first beam indicating the first beam and a selected sync raster associated with the first beam.

2. The apparatus of claim 1, further comprising a transceiver coupled to the at least one processor,
wherein the first set of beams and the second set of beams includes a plurality of synchronization signal blocks (SSBs).

3. The apparatus of claim 1, wherein the response is transmitted via the first beam in a time-domain and the selected sync raster in a frequency-domain.

4. The apparatus of claim 1, wherein the at least one processor is further configured to:
identify that the first beam is not associated with the first sync raster and the second sync raster; and
transmit, to the base station, an indication of the RIS based on the first beam being not associated with the first sync raster and the second sync raster being configured by the base station.

5. The apparatus of claim 1, wherein the at least one processor is further configured to:
receive, from the base station, a configuration of the first sync raster associated with the first set of beams and the second sync raster associated with the second set of beams reflected at the RIS.

6. The apparatus of claim 1, wherein the first sync raster includes a first set of center frequencies and the second sync raster includes a second set of center frequencies, and
wherein the second set of center frequencies is defined by shifting the first set of center frequencies by a RIS frequency offset.

7. The apparatus of claim 1, wherein the at least one processor is further configured to:
receive, from the base station, an indication to monitor the second sync raster,
wherein the second sync raster is monitored for the second set of beams based on receiving the indication to monitor the second sync raster.

8. An apparatus for wireless communication at a base station, comprising:
a memory; and
at least one processor coupled to the memory and configured to, based at least in part on information stored in the memory:
transmit, to a reconfigurable intelligent surface (RIS), a configuration of a second synchronization (sync) raster for the RIS to reflect a first beam into a second set of beams, the second set of beams being associated with the second sync raster; and
transmit a first set of beams including the first beam, the first set of beams being associated with a first sync raster, each beam of the first set of beams being transmitted in different directions.

9. The apparatus of claim 8, wherein the first set of beams and the second set of beams include a plurality of synchronization signal blocks (SSBs).

10. The apparatus of claim 8, wherein the first sync raster includes a first set of center frequencies and the second sync raster includes a second set of center frequencies, and
wherein the second set of center frequencies is defined by shifting the first set of center frequencies by a RIS frequency offset.

11. The apparatus of claim 8, wherein the at least one processor is further configured to:
receive, from a user equipment (UE) via the RIS, a response to a selected beam, the response indicating the selected beam and a selected sync raster associated with the selected beam.

12. The apparatus of claim 11, wherein the response is received from the UE via the RIS using the first beam.

13. The apparatus of claim 8, wherein the at least one processor is further configured to:
transmit, to a user equipment (UE), an indication to monitor the second sync raster,
wherein the second sync raster is monitored for the second set of beams based on receiving the indication to monitor the second sync raster.

14. The apparatus of claim 8, further comprising a transceiver coupled to the at least one processor.

15. An apparatus for wireless communication at a reconfigurable intelligent surface (RIS), comprising:
a memory; and
at least one processor coupled to the memory and configured to, based at least in part on information stored in the memory:
receive, from a base station, a first beam among a first set of beams associated with a first synchronization (sync) raster; and
reflect the first beam into a second set of beams associated with a second sync raster, the second set of beams being reflected simultaneously.

16. The apparatus of claim 15, wherein the first set of beams and the second set of beams include a plurality of synchronization signal blocks (SSBs).

17. The apparatus of claim 15, wherein the at least one processor is further configured to:
receive, from the base station, a configuration of the second sync raster.

18. The apparatus of claim 15, wherein the first sync raster includes a first set of center frequencies and the second sync raster includes a second set of center frequencies, and
wherein the second set of center frequencies is defined by shifting the first set of center frequencies by a RIS frequency offset.

19. The apparatus of claim 15, wherein the at least one processor is further configured to:
receive, from a user equipment (UE), a response to a selected beam, the response indicating the selected beam and a selected sync raster associated with the selected beam; and
reflect the response associated with the selected beam to the base station.

20. The apparatus of claim 19, wherein the response is received from the UE with the selected beam in a time-domain and the selected sync raster in a frequency-domain.

21. The apparatus of claim 19, wherein the response is reflected to the base station by the RIS.

22. The apparatus of claim 15, further comprising a plurality of sub-RISs, wherein the plurality of sub-RISs is associated with the second sync raster and the first beam is reflected by the plurality of sub-RISs into the second set of beams associated with the second sync raster simultaneously.

23. The apparatus of claim 15, further comprising a transceiver coupled to the at least one processor.

24. A method of wireless communication at a user equipment (UE), comprising:
monitoring a first synchronization (sync) raster and a second sync raster for a set of beams including a second set of beams being simultaneously received and associated with the second sync raster, the first sync raster being associated with a first set of beams from a base station and the second sync raster being associated with the second set of beams reflected at a reconfigurable intelligent surface (RIS);
selecting a first beam of the set of beams, the first beam being a most suitable beam among the set of beams; and
transmitting, to the base station, a response to the first beam indicating the first beam and a selected sync raster associated with the first beam.

25. The method of claim 24, wherein the first set of beams and the second set of beams includes a plurality of synchronization signal blocks (SSBs).

26. The method of claim 24, wherein the response is transmitted via the first beam in a time-domain and the selected sync raster in a frequency-domain.

27. The method of claim 24, further comprising:
identifying that the first beam is not associated with the first sync raster and the second sync raster; and
transmitting, to the base station, an indication of the RIS based on the first beam being not associated with the first sync raster and the second sync raster being configured by the base station.

28. The method of claim 24, further comprising:
receiving, from the base station, a configuration of the first sync raster associated with the first set of beams and the second sync raster associated with the second set of beams reflected at the RIS.

29. The method of claim 24, wherein the first sync raster includes a first set of center frequencies and the second sync raster includes a second set of center frequencies, and
wherein the second set of center frequencies is defined by shifting the first set of center frequencies by a RIS frequency offset.

30. The method of claim 24, further comprising:
receiving, from the base station, an indication to monitor the second sync raster,
wherein the second sync raster is monitored for the second set of beams based on receiving the indication to monitor the second sync raster.
